(19) United States
(12) Patent Application Publication
(10) Pub. No.: US 2026/0300792 A1
(43) Pub. Date: Oct. 1, 2026

(54) CONFINEMENT APPARATUS ASSEMBLY WITH INTEGRATED TRANSPARENT CONDUCTIVE WINDOWS AND METHODS FOR FABRICATION THEREOF

(71) Applicant: Quantinuum LLC, Broomfield, CO (US)

(72) Inventors: Christopher T. ERTSGAARD, Champlin, MN (US); Todd Michael KLEIN, Wayzata, MN (US)

(21) Appl. No.: 19/629,237

(22) Filed: Mar. 26, 2026

Related U.S. Application Data
(60) Provisional application No. 63/778,776, filed on Mar. 27, 2025.

(51) Int. Cl. G06N 10/40

(52) U.S. Cl. CPC G06N 10/40

(57) ABSTRACT

A confinement apparatus assembly includes a chip configured for delivering a manipulation signal to a target location. The chip includes a plurality of layers. The plurality of layers include sub-surface layers and a patterned conductive layer disposed at a delivery surface of the chip. The chip further includes a transparent conductive film (TCF) disposed between the patterned conductive layer and at least one of the sub-surface layers such that the TCF is in electrical communication with at least a portion of the patterned conductive layer. The patterned conductive layer may be/include electrodes, a ground plane, and/or the like.

### CROSS-REFERENCE TO RELATED APPLICATION(S)

This application claims priority to U.S. Application No. 63/778,776, field Mar. 27, 2025, the content of which is incorporated herein by reference in its entirety.

### TECHNICAL FIELD

Various embodiments relate to confinement apparatus assemblies and systems including confinement apparatus assemblies that have integrated transparent conductive windows. Various embodiments relate to fabricating confinement apparatus assemblies having integrated transparent conductive windows.

### BACKGROUND

A confinement apparatus may be used to confine quantum and/or atomic objects for use in performing various experiments, controlled quantum state evolution, and/or the like. The quantum and/or atomic objects may be interacted with (e.g., to perform experiments, cause controlled quantum state evolution, and/or the like) via optical signals (e.g., laser beams), microwaves, magnetic fields, and/or the like. When optical signals are used to interact with the quantum and/or atomic objects confined by a large confinement apparatus (e.g., configured to confine tens, hundreds, or more quantum and/or atomic objects), precise delivery of the optical signals to target locations is important for performing high fidelity interactions with the quantum and/or atomic objects and to prevent cross-talk errors. One proposal is to integrate optical routing layers into a chip housing the confinement apparatus and/or another chip secured with respect to the confinement apparatus. For example, transparent windows may be integrated into the surface of the confinement apparatus such that optical signals may be provided through the windows.

However, the presence of transparent windows through the top metal of the confinement apparatus may result in charge build up on the windows. The charge build up on the windows may cause the quantum and/or atomic objects to experience spurious electric fields, resulting in errors being present in the experiments being performed using the quantum and/or atomic objects. Through applied effort, ingenuity, and innovation many deficiencies of such prior confinement apparatuses have been solved by developing solutions that are structured in accordance with the embodiments of the present invention, many examples of which are described in detail herein.

### BRIEF SUMMARY OF EXAMPLE EMBODIMENTS

Example embodiments provide confinement apparatus assemblies; quantum computers, atomic systems, and/or quantum systems comprising confinement apparatus assemblies; and/or the like. The confinement apparatus assemblies include integrated transparent conductive windows that are integrated into the confinement apparatus assembly between a patterned conductive layer (e.g., a top metal or electrode layer) and an insulating layer (e.g., a dielectric layer). The confinement apparatus may also include gaps between adjacent segments or electrodes of the patterned conductive layer or load holes that are overhung by the neighboring segments or electrodes of the patterned conductive layer.

Example embodiments provide methods for fabricating confinement apparatus assemblies where the transparent conductive film (TCF) of a transparent conductive window is present for one or more confinement apparatus fabrication operations, such as the fabrication of the patterned conductive layer, undercut etches between adjacent segments and/or electrodes of the patterned conductive layer, load hole etches, patterned conductive layer clean-up, die singulation, wafer bonding, die bonding, bump-bonding, and/or chip packaging. Some embodiments include processes and/or procedures for protecting the TCF of a transparent conductive window during performance of confinement apparatus fabrication operations. Some embodiments include processes and/or procedures for repairing the TCF of a transparent conductive window that occurs during performance of confinement apparatus fabrication operations.

According to one aspect, a chip of a confinement apparatus assembly is provided. The chip is configured for delivering a manipulation signal to a target location. The chip includes a plurality of layers. The plurality of layers include a patterned conductive layer disposed at a delivery surface of the chip and one or more sub-surface layers, the one or more sub-surface layers comprising at least one of (a) one or more optical routing layers comprising at least one waveguide or (b) one or more electrical routing layers. A window opening is disposed in the patterned conductive layer and defines an opening area. A transparent conductive film (TCF) of a transparent conductive window is disposed between the patterned conductive layer and at the one or more sub-surface layers such that the TCF is in electrical communication with at least a portion of the patterned conductive layer and the TCF is aligned with the window opening.

In an example embodiment, one or more through holes are formed through the plurality of layers.

In an example embodiment, respective portions of the patterned conductive layer overhang the one or more through holes.

In an example embodiment, the chip further includes an insulating layer disposed between the optical routing layer and the patterned conductive layer, wherein the patterned conductive layer is segmented into conductive segments that are spatially separated and/or electrically insulated from one another with respective gaps in the insulating layer between adjacent conductive segments.

In an example embodiment, the adjacent conductive segments overhang the respective gaps.

In an example embodiment, the TCF extends between the insulating layer and the patterned conductive layer beyond an edge of the window opening.

In an example embodiment, the chip further includes one or more intermediate conductive layers disposed between the optical routing layer and the insulating layer, the one or more intermediate conductive layers being patterned to include respective apertures therethrough and/or transparent portions that are optically aligned with the TCF and the window opening.

In an example embodiment, the optical routing layer comprises at least one coupler configured to couple the manipulation signal out of the at least one waveguide such that the manipulation signal propagates through the window and through the window opening to the target location.

In an example embodiment, the manipulation signal is a laser beam.

In an example embodiment, the at least one coupler is configured to control one or more optical properties of the manipulation signal.

In an example embodiment, the chip hosts a confinement apparatus configured to confine one or more quantum objects in a confinement region proximate the delivery surface and the patterned conductive layer comprises a plurality of electrodes of the confinement apparatus.

In an example embodiment, the chip is configured to be secured with respect to a confinement apparatus such that the delivery surface faces a confinement region defined by the confinement apparatus.

In an example embodiment, the patterned conductive layer is at least one of a ground plane, a magnetic field generating component, a direct current electric field generating component, or an alternating current electric field component.

In an example embodiment, the TCF comprises a transparent conductive oxide (TCO).

According to another aspect, a chip that is part of a confinement apparatus assembly is provided. The chip is configured for delivering a manipulation signal to a target location. In an example embodiment, the chip includes a patterned conductive layer and a plurality of sub-surface layers including an insulating layer comprising a dielectric material and at least one of (a) an optical routing layer comprising at least one waveguide or (b) an electrical routing layer..; The insulating layer is disposed between the patterned conductive layer and the at least one of (a) an optical routing layer or (b) an electrical routing layer. The patterned conductive layer includes at least one window opening defining an opening area. At least one window is disposed between the insulating layer and the patterned conductive layer. The at least one window comprising a transparent conductive film (TCF). The window is aligned with the at least one window opening in the patterned conductive layer. The window defines a window area, and the window area is larger than the opening area.

In an example embodiment, one or more through holes are formed through the optical routing layer, insulating layer, and patterned conductive layer.

In an example embodiment, respective portions of the patterned conductive layer overhang the one or more through holes.

In an example embodiment, the patterned conductive layer is segmented into conductive segments with respective gaps in the insulating layer between adjacent conductive segments.

In an example embodiment, the adjacent conductive segments overhang the respective gaps.

In an example embodiment, the optical routing layer comprises at least one coupler configured to couple the manipulation signal out of the at least one waveguide such that the manipulation signal propagates through the at least one window and through the window opening to the target location.

In an example embodiment, the chip hosts a confinement apparatus configured to confine one or more quantum objects in a confinement region proximate the delivery surface and the patterned conductive layer comprises a plurality of electrodes of the confinement apparatus.

In an example embodiment, the chip is configured to be secured with respect to a confinement apparatus such that the delivery surface faces a confinement region defined by the confinement apparatus.

In an example embodiment, the TCF comprises a transparent conductive oxide (TCO).

In an example embodiment, the chip further includes one or more intermediate conductive layers disposed between the optical routing layer and the insulating layer, the one or more intermediate conductive layer being patterned to include respective apertures therethrough and/or transparent portions that are optically aligned with the at least one window and the window opening.

According to another aspect, a method of fabricating a chip including a transparent conductive window is provided. In an example embodiment, the method includes depositing a transparent conductive layer on an insulating layer, the insulating layer being part of a substrate including an optical routing layer including at least one waveguide; patterning the transparent conductive layer to form a transparent conductive film (TCF) of at least one transparent conductive window optically aligned with a coupler of the at least one waveguide; depositing a non-transparent conductive layer on the insulating layer and the TCF; and patterning the non-transparent conductive layer to form a patterned conductive layer, the patterned conductive layer comprising at least one window opening that is aligned with the TCF.

In an example embodiment, the at least one window opening is formed such that the TCF of the transparent conductive window extends between the insulating layer and the patterned conductive layer around a perimeter of the at least one window opening.

In an example embodiment, the method further includes, after patterning the non-transparent conductive layer to form the patterned conductive layer, performing one or more additional processes.

In an example embodiment, the one or more additional processes comprise an O₂ plasma clean of the patterned conductive layer.

In an example embodiment, the method further includes, after performance of the one or more additional processes, performing a low oxygen environment annealing process to cause oxygen to be released from the TCF of the transparent conductive window.

In an example embodiment, the annealing process comprises heating the chip to a temperature between 250 and 500 degrees Celsius for a time of at least half an hour.

In an example embodiment, the annealing process is performed for a time of up to 48 hours.

In an example embodiment, the low oxygen environment is one of a vacuum environment or an environment having a gas flow of a gas that substantially does not include oxygen.

In an example embodiment, the method further includes, after performance of the one or more additional processes, performing a controlled surface clean to remove one or more atomic layers from the TCF of the transparent conductive window.

In an example embodiment, the method further includes, prior to performing the one or more additional processes, depositing and patterning at least one protective layer in the at least one window opening and, after performing the one or more additional processes, removing the at least one protective layer.

In an example embodiment, removing the at least one protective layer comprises performing a selective chemical etch that does not substantially affect materials of the chip other than the at least one protective layer.

In an example embodiment, the at least one protective layer comprises a primary protective layer deposited onto the TCF and a secondary protective layer deposited onto the primary protective layer.

In an example embodiment, the secondary protective layer is removed, after performance of the one or more additional processes, using a dry etch and the primary protective layer is removed using a selective chemical etch.

In an example embodiment, the at least one protective layer is patterned so as to prevent over-etching of the TCF during patterning.

In an example embodiment, the transparent conductive layer is patterned using a hard mask.

In an example embodiment, the transparent conductive layer is patterned using a dry etch followed by a wet etch.

In an example embodiment, the non-transparent conductive layer is deposited and patterned such that the TCF of the transparent conductive window is in direct electrical communication with at least a portion of the patterned conductive layer.

In an example embodiment, an electrical resistance between the TCF and the at least a portion of the patterned conductive layer is no more than 200 ohms.

In an example embodiment, patterning the non-transparent conductive layer comprises patterning the non-transparent conductive layer into segments of the patterned conductive layer and etching gaps into the insulating layer between adjacent segments.

In an example embodiment, adjacent segments of the patterned conductive layer are configured to overhang a gap formed in the insulating layer between the adjacent segments.

In an example embodiment, the optical routing layer comprises a coupler in optical communication with the at least one waveguide and configured to couple manipulation signals out of the at least one waveguide, wherein the TCF and the at least one window opening are patterned so as to be optically aligned with the coupler.

In an example embodiment, the insulating layer is substantially planar when the transparent conducting layer is deposited thereon.

According to another aspect, a method of fabricating a chip of a confinement apparatus assembly including a transparent conductive window. In an example embodiment, the method includes forming a transparent conductive film (TCF) having a primary protective layer formed thereon, the TCF formed on an insulating layer that is part of a substrate including an optical routing layer including at least one waveguide; depositing a non-transparent conductive layer on an exposed surface of the substrate; and patterning the non-transparent conductive layer to form a patterned conductive layer, wherein patterning the non-transparent conductive layer comprises etching at least one window opening that is optically aligned with the TCF.

In an example embodiment, the insulating layer is substantially planer when the TCF is formed thereon.

In an example embodiment, forming the TCF having the primary protective layer formed thereon includes depositing a transparent conductive layer on the insulating layer; depositing the primary protective layer on the transparent conductive layer; and patterning the transparent conductive layer and the primary protective layer to form the TCF having the first protective layer formed thereon.

In an example embodiment, forming the TCF having the primary protective layer formed thereon includes depositing a transparent conductive layer on the insulating layer; patterning the transparent conductive layer to form the TCF; and depositing and patterning the primary protective layer on the TCF.

In an example embodiment, forming the TCF having the primary protective layer formed thereon includes depositing a transparent conductive layer on the insulating layer; and depositing and patterning the primary protective layer on the TCF.

In an example embodiment, forming the TCF having the primary protective layer formed thereon includes depositing a transparent conductive layer on the insulating layer; depositing the primary protective layer on the TCF, and patterning the transparent conductive layer and the primary protective layer during or after patterning of the patterned conductive layer (e.g., a top metal or electrode layer).

In an example embodiment, the primary protective layer is electrically conductive and is in direct electrical communication with at least a portion of the patterned conductive layer and with the TCF.

In an example embodiment, the method further includes, after etching the at least one window opening, removing at least a portion of the primary protective layer using a selective chemical etch.

In an example embodiment, the selective chemical etch does not substantially interact with any exposed materials of the chip other than the primary protective layer.

In an example embodiment, the removal of at least a portion of the primary protective layer is performed after performance of at least one of undercut etches, load hole etches, patterned conductive layer clean-up, die singulation, wafer bonding, die bonding, bump-bonding, or chip packaging.

In an example embodiment, the method further includes, prior to depositing the non-transparent conductive layer, depositing and patterning a secondary protective layer on the primary protective layer.

In an example embodiment, etching the at least one window opening includes using the secondary protective layer as an etch stop.

In an example embodiment, the method further includes, after etching the at least one window opening, removing at least a portion of the secondary protective layer using a dry etch.

In an example embodiment, the primary protective layer comprises TiW and the secondary protective layer comprises SiO₂, the primary protective layer comprises TiN and the secondary protective layer comprises Ti or TiW, or only the primary protective layer is used and the primary protective layer comprises TiN.

In an example embodiment, the secondary protective layer is deposited via sputtering.

In an example embodiment, patterning the non-transparent conductive layer to form a patterned conductive layer comprises performing at least one of metal liftoff patterning, direct etch patterning, or damascene patterning.

In an example embodiment, the patterned conductive layer comprises one or more electrodes.

According to another aspect, a method of fabricating a chip of a confinement apparatus assembly and including a transparent conductive window is provided. In an example embodiment, the method includes forming a transparent conductive film (TCF) on an insulating layer that is part of a substrate including an optical routing layer including at least one waveguide; depositing a non-transparent conductive layer on an exposed surface of the substrate; patterning the non-transparent conductive layer to form a patterned conductive layer, wherein patterning the non-transparent conductive layer comprises etching at least one window opening that is optically aligned with the TCF; and performing one or more additional processes. During at least one of the patterning of the non-transparent conductive layer or the performing of the one or more additional processes, the TCF is disposed between the insulating layer and at least one protective layer such that the TCF is not directly affected by the at least one of the patterning of the non-transparent conductive layer or the performing of the one or more additional processes.

In an example embodiment, the one or more additional process include at least one of undercut etching, load hole etching, patterned conductive layer clean-up, die singulation, wafer bonding, die bonding, bump-bonding, and/or chip packaging.

In an example embodiment, the at least one protective layer is at least partially removed after performance of the one or more additional processes.

In an example embodiment, removing the at least one protective layer includes performing a selective chemical etch that does not substantially affect the TCF.

In an example embodiment, the at least one protective layer comprises a primary protective layer that is in direct contact with the TCF and a secondary protective layer formed on the primary protective layer and the secondary protective layer is removed using a dry etch or a wet etch.

According to another aspect, a quantum computer, quantum system, or atomic system is provided. The quantum computer, quantum system, or atomic system includes a confinement apparatus assembly including a chip (e.g., a confinement apparatus chip or second chip) according to an example embodiment and/or a chip (e.g., a confinement apparatus chip or second chip) fabricated in accordance with a method of an example embodiment.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of an example system including a confinement apparatus assembly, in accordance with an example embodiment.

FIG. 2 provides a partial cross-sectional view of an example confinement apparatus assembly, in accordance with an example embodiment.

FIG. 2A provides a top view of an example opening area and an example window area, in accordance with an example embodiment.

FIG. 3 is a partial cross-sectional view of another example confinement apparatus assembly, in accordance with an example embodiment.

FIG. 4 provides a flowchart illustrating various processes, procedures, and/or operations for fabricating a chip of a confinement apparatus assembly that includes at least one transparent conductive window, in accordance with an example embodiment.

FIGS. 5A, 5B, 5C, and 5D are partial cross-sectional views of a chip of a confinement apparatus at respective steps of fabrication, in accordance with an example embodiment.

FIG. 6 provides a flowchart illustrating various processes, procedures, and/or operations performed in patterning a non-transparent conductive layer to form a patterned conductive layer, in accordance with another example embodiment.

FIGS. 7A, 7B, and 7C are partial cross-sectional views of a chip of a confinement apparatus at various steps of fabrication, in accordance with an example embodiment.

FIG. 8 provides a flowchart illustrating various processes, procedures, and/or operations performed in patterning a transparent conductive layer to form one or more transparent conductive films (TCFs) of respective transparent conductive windows, in accordance with an example embodiment.

FIG. 9 provides a flowchart illustrating various processes, procedures, and/or operations performed in patterning a transparent conductive layer to form one or more transparent conductive films (TCFs) of respective transparent conductive windows, in accordance with an example embodiment.

FIG. 10 provides a flowchart illustrating various processes, procedures, and/or operations for fabricating a chip of a confinement apparatus assembly that includes at least one transparent conductive window, in accordance with an example embodiment.

FIG. 11A provides a flowchart illustrating various processes, procedures, and/or operations for forming a TCF of a transparent conductive window having a first protective layer formed thereon, in accordance with an example embodiment.

FIG. 11B provides a flowchart illustrating various processes, procedures, and/or operations for forming a TCF of a transparent conductive window having a first protective layer formed thereon, in accordance with an example embodiment.

FIGS. 12A, 12B, 12C, 12D, 12E, and 12F are partial cross-sectional views of a chip of a confinement apparatus at various steps of fabrication, in accordance with an example embodiment.

FIG. 13 provides a flowchart illustrating various processes, procedures, and/or operations for fabricating a chip of a confinement apparatus assembly that includes at least one transparent conductive window, in accordance with an example embodiment.

FIGS. 14A, 14B, 14C, 14D, 14E, and 14F are partial cross-sectional views of a chip of a confinement apparatus at various steps of fabrication, in accordance with an example embodiment.

FIG. 15 provides a schematic diagram of an example controller of a quantum computer comprising an ion trap apparatus, in accordance with an example embodiment.

FIG. 16 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

### General Overview

Various embodiments provide confinement apparatus assemblies; quantum computers, atomic systems, and/or quantum systems comprising confinement apparatus assemblies; and/or the like. The confinement apparatus assemblies include integrated transparent conductive windows that are integrated into the confinement apparatus assembly (e.g., as part of the confinement apparatus chip and/or as part of a second substrate and/or chip). Each transparent conductive window includes a transparent conductive film (TCF) configured to enable manipulation signal (e.g., optical signals to pass there through) and that are conductive and in electrical communication with various other conductive components of the confinement apparatus assembly to prevent build-up of charge on the TCF or below the TCF. The TCF is disposed between a patterned conductive layer (e.g., a top metal or electrode layer) and an insulating layer (e.g., a dielectric layer) of the respective chip (e.g., the confinement apparatus chip and/or a second substrate and/or chip). The confinement apparatus may also include gaps between adjacent segments or electrodes of the patterned conductive layer or load holes that are overhung by the neighboring segments or electrodes of the patterned conductive layer.

Various embodiments provide methods for fabricating confinement apparatus assemblies where the transparent conductive film (TCF) of a transparent conductive window is present for one or more integrated fabrication operations, such as the fabrication of the patterned conductive layer, undercut etches between adjacent segments and/or electrodes of the patterned conductive layer, load hole etches, patterned conductive layer clean-up, die singulation, wafer bonding, die bonding, bump-bonding, and/or chip packaging. Some embodiments include processes and/or procedures for protecting the TCF of a transparent conductive window during performance of integrated fabrication operations. Some embodiments include processes and/or procedures for repairing the TCF of a transparent conductive window that occurs during performance of integrated fabrication operations.

For example, the TCF film may be damaged and/or saturated with oxygen (or other element and/or chemical) during the performance of the integrated fabrication operations. This may result in the TCF having reduced electrical conductivity, increased electrical contact resistance, reduced optical transparency, and/or the like. Decreased electrical conductivity and/or increased electrical resistance of the TCF may cause heating of quantum and/or atomic objects confined by the confinement apparatus 202 and/or may cause the quantum and/or atomic objects confined by the confinement apparatus 202 to experience spurious electric fields that may result in memory errors and quantum and/or atomic object heating. Reduced optical transparency of the TCF film of a transparent conductive window may reduce the optical power of a manipulation signal and/or affect other optical properties of the manipulation signal that is provided to a target location through the transparent conductive window. Therefore, there are technical problems regarding confinement apparatus assemblies having integrated transparent conductive windows and methods for fabricating such confinement apparatus assemblies.

One solution to these technical problems may be to fabricate the TCF of transparent conductive windows as a final step in the fabrication of the confinement apparatus chip and/or second substrate and/or chip. However, this strategy does not appear to provide sufficient electrical communication between the TCF and the top-metal to prevent excess heating and/or to perform sufficient shielding from spurious electric fields caused by electric charge build-up. Moreover, significant integration challenges exist for integrating TCF after load holes and electrode undercuts are fabricated.

Various embodiments provide technical solutions to these technical challenges. For example, in various embodiments, the TCF of a transparent conductive window is disposed between a patterned conductive layer (e.g., a top metal or electrode layer) and an insulating layer (e.g., a dielectric layer) of the respective chip (e.g., the confinement apparatus chip and/or a second substrate and/or chip). The confinement apparatus may also include gaps between adjacent segments or electrodes of the patterned conductive layer or load holes that are overhung by the neighboring segments or electrodes of the patterned conductive layer. The overhanging portions of the segments or electrodes may provide additional shielding of quantum and/or atomic objects confined by the confinement apparatus from spurious electric fields. In some embodiments, the respective chip further includes one or more intermediate conductive layers disposed between the insulating layer and an optical routing layer of the chip to further shield quantum and/or atomic objects confined by the confinement apparatus from spurious electric fields and/or stray light generated in the electrical routing layers, optical routing layers, and/or other layers of the chip. As used herein, the term optical refers to infrared, visible and/or ultraviolet light. For example, an optical beam is an electromagnetic beam that is characterized by a wavelength in a range of 300 to 2,500 nm/

Some embodiments include processes and/or procedures for protecting the TCF of a transparent conductive window during performance of integrated fabrication operations. Some embodiments include processes and/or procedures for repairing the TCF of a transparent conductive window that occurs during performance of integrated fabrication operations. These processes and/or procedures for protecting and/or repairing the TCF of a transparent conductive window provide transparent conductive windows having TCFs integrated between the patterned conductive layer and the insulating layer of the respective chip to provide sufficient electrical communication between the TCF and patterned conductive layer where the TCF has sufficient electrical conductivity and optical transparency to effectively prevent excess heating of quantum and/or atomic objects confined by the confinement apparatus, shield quantum and/or atomic objects confined by the confinement apparatus from spurious electric fields, and provide manipulation signals (e.g., optical signals) of desired optical properties.

Therefore, various embodiments provide improvements to the fields of confinement apparatus assemblies including integrated photonics, systems including confinement apparatus assemblies that use integrated photonics for manipulating confined quantum and/or atomic objects, and/or the like.

### Example System Including a Confinement Apparatus Assembly

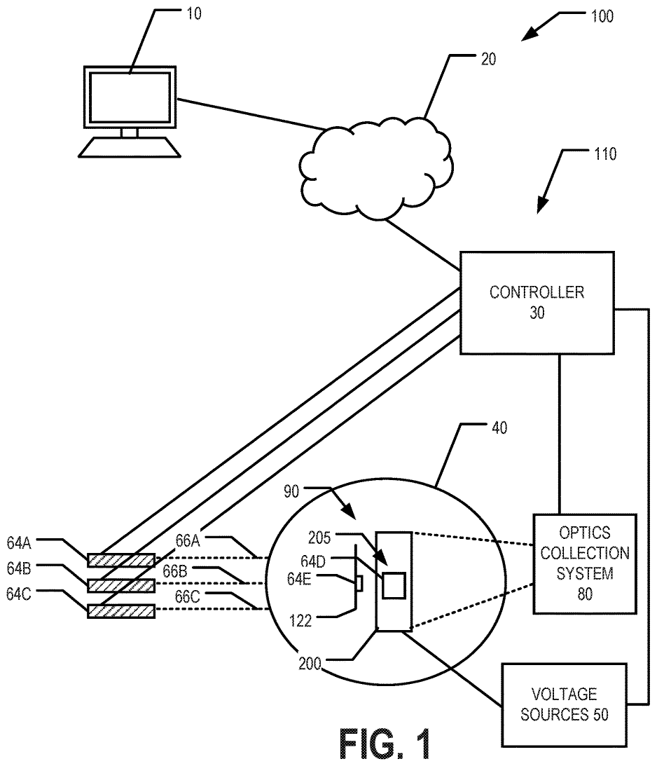

Various embodiments provide quantum systems, atomic systems, and/or quantum computers (e.g., QCCD-based quantum computers) that use quantum and/or atomic objects confined and/or trapped by a confinement apparatus of a confinement apparatus assembly for storing quantum information, performing quantum computations, performing experiments, and/or the like. FIG. 1 provides a schematic diagram of an example quantum computer system 100 comprising a confinement apparatus assembly 90 including a confinement apparatus chip 200, in accordance with various embodiments. In various embodiments, the confinement apparatus chip 200 hosts electrodes of a confinement apparatus, such as an ion trap and/or the like. For example, the confinement apparatus is a surface ion trap apparatus, Paul ion trap apparatus, and/or the like, in certain embodiments.

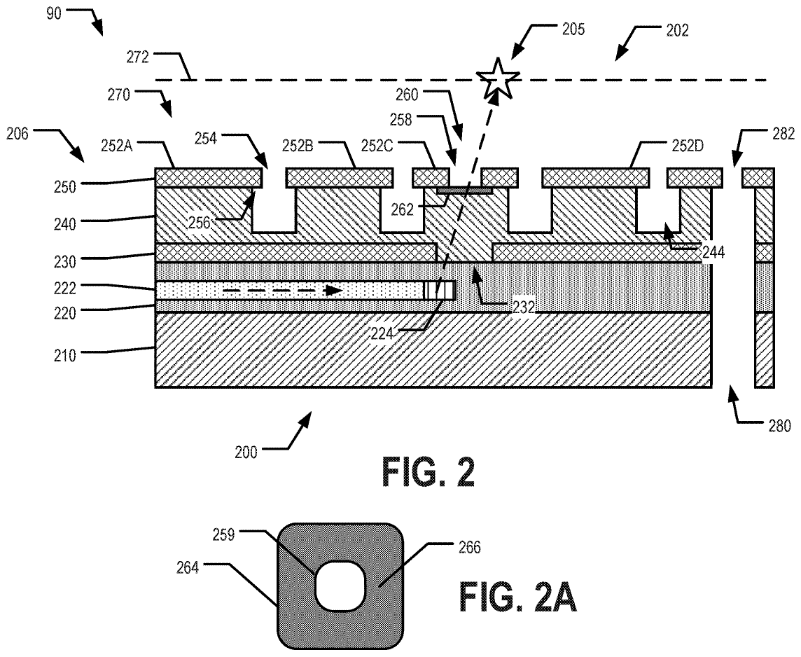

In the illustrated embodiment, the quantum computer system 100 includes a confinement apparatus chip 200 configured to define and/or generate a confinement apparatus 202 configured to confine a plurality of quantum and/or atomic objects (e.g., ions, ionic molecules, multi-polar molecules, neutral atoms, neutral molecules, polar molecules, quantum particles, and/or the like), as shown in FIG. 2. In various embodiments, the quantum and/or atomic objects are used as qubits of the quantum computer 110.

In various embodiments, the quantum computer system 100 comprises a classical (e.g., semiconductor-based) computing entity 10 and a quantum computer 110. In various embodiments, the quantum computer 110 comprises a controller 30, a cryostat and/or vacuum chamber 40 enclosing a confinement apparatus assembly 90, one or more manipulation sources 64 (e.g., 64A, 64B, 64C, 64D, 64E), one or more voltage sources 50, components of an optics collection system 80, one or more sensors (e.g., calibration sensors and/or the like), and/or the like. In various embodiments, the controller 30 is configured to control the operation of (e.g., control one or more drivers configured to cause operation of) the manipulation sources 64, voltage sources 50, a vacuum system and/or cryogenic cooling system (not shown), and/or the like. In various embodiments, the controller 30 is configured to receive sensor signals (e.g., electrical signals) generated and provided by one or more photodetectors of the optics collection system 80 and/or other sensors of the system.

In an example embodiment, the confinement apparatus assembly includes a second substrate or chip 122 may be secured into relationship with the confinement apparatus chip 200 and house one or more components of the system (e.g., one or more manipulation sources 64E, one or more optical components of a beam path system 66 (e.g., 66A, 66B, 66C), one or more components of the optics collection system 80, one or more sensors, and/or the like).

In an example embodiment, the one or more manipulation sources 64 may comprise one or more lasers (e.g., optical lasers, microwave sources and/or masers, and/or the like) or another manipulation source. In the illustrated embodiment, manipulation sources 64A, 64B, 64C are lasers located outside of the cryogenic and/or vacuum chamber 40. Manipulation source 64D is a laser, microwave source, or magnetic field or magnetic field gradient source (e.g., permanent magnets, Helmholtz coils, electrical magnets, integrated circuits, and/or the like) that is integrated with and/or hosted by the confinement apparatus chip 200. In an example embodiment, a manipulation source 64E is a laser, microwave source, or magnetic field or magnetic field gradient source (e.g., permanent magnets, Helmholtz coils, electrical magnets, integrated circuits, and/or the like) that is integrated with and/or hosted by the second substrate or chip 122.

In various embodiments, the one or more manipulation sources 64 are configured to manipulate and/or cause a controlled quantum state evolution of one or more quantum and/or atomic objects confined by the confinement apparatus 202 defined (see FIG. 2). In various embodiments, one or more manipulation sources 64 are configured to generate and/or provide one or more manipulation signals configured for performing one or more quantum operations such as laser cooling, qubit initialization and/or state preparation, shelving operations, single qubit gates, two-qubit gates, fluorescence measurement operations, and/or other operations on quantum and/or atomic objects confined by the confinement apparatus 202 and/or the confinement apparatus assembly 90.

In an example embodiment, the one or more manipulation sources 64A, 64B, 64C (located outside of the cryogenic and/or vacuum chamber 40) each provide a manipulation signal (e.g., laser beam, microwave signals, and/or the like) to one or more regions and/or target locations 205 defined at least in part by the confinement apparatus 202 and/or the confinement apparatus assembly 90 via corresponding beam path systems 66 (e.g., 66A, 66B, 66C). In certain embodiments, at least a portion of at least one beam path system is disposed within an optical routing layer of the confinement apparatus chip 200 and/or the second substrate and/or chip 122. For example, in various embodiments, at least one of the one or more beam path systems 66 includes a waveguide integrated into an optical routing layer of the confinement apparatus chip 200 and/or the second substrate and/or chip 122 and provided to the target location 205 via a transparent conductive window. In various embodiments, at least one beam path system 66 comprises a modulator configured to modulate the manipulation signal being provided to the target location 205 via the beam path system 66. In various embodiments, the manipulation sources 64, active components of the beam path systems 66 (e.g., modulators, etc.), and/or other components of the quantum computer 110 are controlled by the controller 30.

In various embodiments, the quantum computer 110 comprises one or more voltage sources 50. For example, the voltage sources may be arbitrary wave generators (AWG), digital analog converters (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes, shim electrodes, and/or RF rail electrodes) of the confinement apparatus 202, in an example embodiment. For example, the controller 30 may control operation of the one or more voltage sources 50 to cause the confinement apparatus 202 to generate and/or define a trapping (pseudo-)potential configured to confine one or more quantum and/or atomic objects at a target location 205 for performance of controlled quantum state evolution thereon. For example, in some embodiments, the controller 30 controls operation of the confinement apparatus 202 by controlling operation of the voltage sources 50 configured to provide respective voltage signals to respective electrodes, for example, of the confinement apparatus 202.

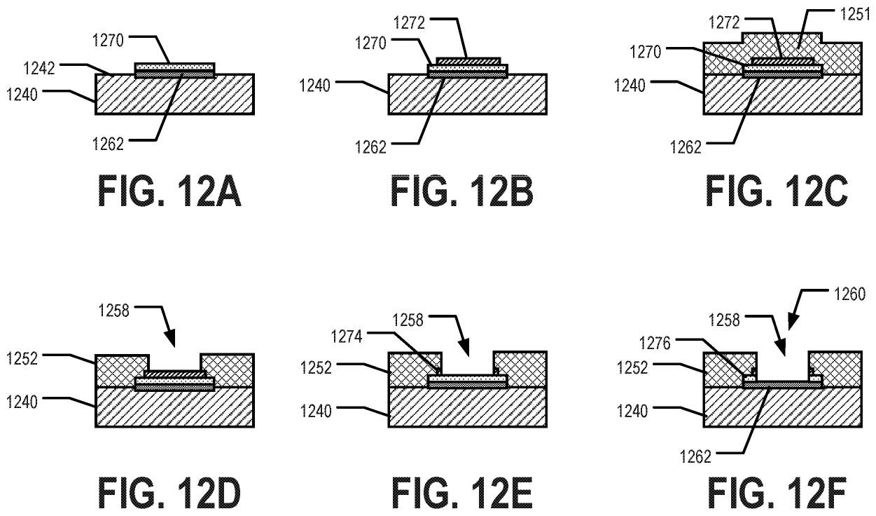

In various embodiments, the quantum computer 110 comprises an optics collection system 80 configured to collect and/or detect photons (e.g., stimulated emission) generated by quantum objects (e.g., during reading procedures). The optics collection system 80 may comprise one or more optical elements (e.g., lenses, mirrors, waveguides, fiber optics cables, and/or the like) and one or more sensors, such as photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits (e.g., quantum objects) of the quantum computer 110. In various embodiments, the sensors (e.g., photodetectors) are in electronic communication with the controller 30 via one or more A/D converters 1225 (see FIG. 12) and/or the like.

In various embodiments, the quantum computer may include various other sensors configured for measuring voltage, current, optical power, magnetic fields, and/or the like at various locations within the quantum computer. The sensors may be used to perform calibration of voltage signals or manipulation signals, calibration and/or monitoring of electric and/or magnetic fields in vicinity of the confinement apparatus 202, calibration of photodetectors of the optics collection system 80, and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 50, cryogenic system and/or vacuum system controlling the temperature and pressure within the cryogenic and/or vacuum chamber 40, manipulation sources 64, beam path systems 66, and/or other systems controlling various environmental conditions (e.g., temperature, pressure, and/or the like) within the cryogenic and/or vacuum chamber 40, configured to manipulate and/or cause a controlled evolution of quantum states of one or more quantum and/or atomic objects confined by the confinement apparatus, and/or read and/or detect a quantum (e.g., qubit) state of one or more quantum and/or atomic objects confined by the confinement apparatus 202. In various embodiments, the controller 30 controls operation of the confinement apparatus 202 (e.g., to generate and/or define the trapping (pseudo-)potential) via controlling operation of the one or more voltage sources 50 to cause desired sequences of voltage signals to be applied to electrodes of the confinement apparatus 202 (e.g., segments of the patterned conductive layer). For example, the controller 30 may cause a controlled evolution of quantum states of one or more ions within the confinement apparatus to execute a quantum circuit and/or algorithm.

### Example Confinement Apparatus Assembly

In various embodiments, a confinement apparatus assembly includes a confinement apparatus configured to confine or trap a plurality of quantum and/or atomic objects. In various embodiments, the confinement apparatus assembly includes integrated optical components configured to provide one or more manipulation signals (e.g., optical signals, laser beams, and/or the like) to at least one target location 205 for interaction with at least one of the plurality of quantum and/or atomic objects.

FIG. 2 provides a cross-sectional view of a portion of an example confinement apparatus assembly 90 comprising a confinement apparatus chip 200, according to an example embodiment. The confinement apparatus chip 200 includes an optical routing layer 220 and a transparent conductive window 260 including a TCF 262 disposed between a patterned conductive layer 250 and an insulating layer 240. While FIG. 2 illustrates a portion of the confinement apparatus chip 200 that only includes one transparent conductive window, it should be appreciated that the confinement apparatus chip of various embodiments may include a plurality of transparent conductive windows 260 each including a respective TCF 262 and defined at least in part by a respective window opening 258.

In various embodiments, the confinement apparatus chip 200 includes a confinement apparatus 202 formed on a substrate 206. In various embodiments, the substrate 206 includes a plurality of sub-surface layers such as one or more base layers 210, one or more optical routing layers 220, one or more intermediate conductive layers 230, an insulating layer 240, and/or the like. In various embodiments, the confinement apparatus 202 comprises a plurality of segments 252 (e.g., 252A, 252B, 252C, 252D) of a patterned conductive layer 250 formed on the substrate 206 and electrical leads, traces, and/or vias configured to provide voltage signals to respective segments 252 of the patterned conductive layer 250. For example, the segments 252 of the patterned conductive layer 250 are electrodes (e.g., control electrodes, shim electrodes, and/or RF electrodes), in various embodiments.

The one or more base layers 210 may include a wafer or chip substrate (e.g., a silicon wafer or portion thereof). The one or more base layers 210 may further include one or more electrical routing layers configured for routing electrical signals to the segments 252 of the patterned conductive layer 250 and/or the like.

In various embodiments, an optical routing layer 220 comprises one or more waveguides 222 each configured to guide one or more guided modes and/or manipulation signals through at least a portion of the confinement apparatus chip 200. The optical routing layer 220 further comprises one or more couplers 224 each in optical communication with a respective waveguide 222 of the one or more waveguides. For example, a coupler 224 may be configured to couple a manipulation signal out of the respective waveguide 222 such that the manipulation signal propagates through a transparent conductive window 260 that is optically aligned with the coupler 224 and is incident at a respective target location 205. Two or more optical components are “optically aligned” when they are disposed along the same optical path and/or define, at least in part, respective portions of the same optical path. In some embodiments, a coupler 224 is configured to receive a collection signal (e.g., photons emitted and/or fluoresced by a quantum and/or atomic object at the target location 205) via the transparent conductive window 260 that is optically aligned with the coupler 224 and then to couple the collection signal into the waveguide 222. In various embodiments, a coupler 224 may comprise a grating coupler, metasurface, mirror, and/or other component configured to couple manipulation signals (e.g., optical signals and/or laser beams/pulses) into and/or out of a waveguide.

In some embodiments, a transparent conductive window is optically aligned with an optical access point. Some non-limiting examples of optical access points include a coupler of the optical routing layer, die text, fiber viewpoints, and singulation streets. For example, an optical access point may be a portion or component of the substrate 206 (e.g., of a sub-surface layer of the chip hosting the confinement apparatus 202).

For example, as shown by the dashed arrows, in certain embodiments, a manipulation signal may propagate through the waveguide 222 of the optical routing layer 220, be out-coupled from the waveguide 222 by the coupler 224 and propagate through an aperture 232 and/or transparent portion in the intermediate conductive layer, through the insulating layer 240, and through a transparent conductive window 260 (e.g., comprising TCF 262 and window opening 258) to be incident at a target location 205. In certain embodiments, a TCF may span at least a portion of the aperture 232. For example, the aperture 232 may comprise a TCF that is in electrical communication with the intermediate conductive layer 230. In various embodiments, the TCF 262 comprises a transparent conductive oxide (TCO) such as indium tin oxide (ITO), Al doped ZnO, and/or the like.

In various embodiment, the coupler 224 is configured to control one or more optical properties of the manipulation signal that is incident on at the target location 205. For example, the coupler 224 may be configured to control the polarization, wavelength/frequency, optical mode, relative phase, focal point, beam dispersion, direction of propagation, and/or other optical properties of the manipulation signal.

In an example embodiment, a metasurface may be disposed along the optical path between the coupler 224 and the transparent conductive window 260 and/or the target location 205. For example, in certain embodiments one or more metasurfaces may be disposed within the insulating layer 240.

In various embodiments, the intermediate conductive layer(s) 230 acts to at least partially shield the confinement region 272 from spurious electric generated within the one or more base layers 210 and/or the optical routing layer 220. In various embodiments, the target location 205 is located at the confinement region 272. For example, the intermediate conductive layer 230 may comprise a layer of a metal or other conductive material that is patterned to include one or more apertures 232 that are optically aligned with respective couplers 224 and transparent conductive windows 260. In some embodiments, an intermediate conductive layer includes one or more transparent portions (e.g., possibly formed of a transparent conductive material) that are optically aligned with respective couplers 224 and transparent conductive windows 260. For example, the apertures 232 are configured to enable manipulation signals and/or collection signals to propagate through the intermediate conductive layer 230. In various embodiments, the patterned conductive layer 250 includes inter-segment openings 254 that separate and/or electrically insulate adjacent segments 252 from one another. In various embodiments, the intermediate conductive layer 230 is configured to prevent electric fields generated within the one or more base layers 210 and/or one or more optical routing layers 220 or stray light (e.g., from the one or more optical routing layers 220) from reaching the confinement region 272 through the inter-segment openings 254. For example, the one or more apertures 232 of the intermediate conductive layer 230 are not aligned with the inter-segment openings 254.

In various embodiments, the insulating layer 240 is a dielectric layer configured to electrically insulate the patterned conductive layer 250 from the optical routing layer(s) 220 and, possibly, from the base layer(s) 210. In various embodiments, gaps 244 may be etched into the insulating layer 240 beneath the inter-segment openings 254. In various embodiments, the substrate 206 may include various layers between the optical routing layer 220 and the patterned conductive layer 250 as an alternative and/or in addition to the intermediate conductive layer 230 and/or insulating layer 240.

In various embodiments, the patterned conductive layer 250 comprises a plurality of segments 252 patterned out of a conductive and/or metal material. The patterned conductive layer 250 defines a delivery surface 270 of the confinement apparatus chip 200. The delivery surface 270 is the surface of the confinement apparatus chip 200 that faces the confinement region 272 defined by the confinement apparatus 202. In various embodiments, the segments 252 of the patterned conductive layer 250 are electrodes of the confinement apparatus 202. In various embodiments, application of respective voltage signals to the segments 252 generates a trapping (pseudo-)potential that defines a confinement region 272 in which quantum and/or atomic objects may be confined.

In various embodiments, the patterned conductive layer 250 includes inter-segment openings 254 and window openings 258. In certain embodiments, the patterned conductive layer 250 includes one or more load hole openings 282. In various embodiments, a load hole 280 is a through hole through the confinement apparatus chip 200 configured to enable loading of quantum and/or atomic objects into the confinement apparatus 202. In various embodiments, the segments 252 of the patterned conductive layer 250 overhang the inter-segment openings 254 and/or load hold openings 282. For example, an overhang portions 256 of segments extend over the gaps 244 and/or load hole 280.

In various embodiments, the window opening 258 defines an opening area 259 in a plane parallel to the delivery surface 270 and/or the confinement region 272, as shown in FIG. 2A. In certain embodiments, the confinement region 272 may be substantially planar (e.g., planar other than perturbations caused by non-uniformities arising during fabrication, and/or the like), a two-dimensional array of one-dimensional segments, and/or the like. The TCF 262 defines a window area 264 in a plane parallel to the delivery surface 270 and/or the confinement region 272. The window area 264 is larger than the opening area 259. For example, the TCF 262 extends under the segment 252C in which the window opening 258 is located. For example, the TCF extends under the segment 252C beyond the edges of the window opening 258. In some embodiments, the opening area 259 is substantially centered on the window area 264, as shown in FIG. 2A. In some embodiments, the TCF extends generally between the insulating layer 240 and the patterned (non-transparent) conductive layer 250. For example, the patterned conductive layer 250 layer may not be in direct contact with the insulating layer 240 and the TCF 262 may be an intermediary layer between the insulating layer 240 and the patterned conductive layer 250.

The TCF 262 is in electrical communication with the segment 252C within which the window opening 258 is located. For example, the contact portion 266 of the TCF 262 is in electrical contact (e.g., in direct physical contact and/or is in contact via an electrically conductive material) with the segment 252C. The contact portion 266 of the TCF 262 (e.g., the portion of the window area 264 that does not correspond and/or is not aligned with the opening area 259). In various embodiments, the TCF 262 is in electrical communication with the segment 252C in which the window opening 258 is located such that an electrical resistance between the TCF 262 of the transparent conductive window 260 and the at least a portion of the patterned conductive layer (e.g., the segment 252C) is no more than 1 kOhm. In some embodiments, the electrical resistance between the TCF 262 and the segment 252C is less than 100 ohms, less than 50 ohms, less than 10 ohms, or less than 6 ohms.

FIG. 3 provides a cross-sectional view of a portion of an example confinement apparatus assembly 90 comprising a confinement apparatus chip 200′ and a second chip 300. In various embodiments, the second chip 300 is secured and/or mounted with respect to the confinement apparatus chip 200′ (or the confinement apparatus chip 200) to provide one or more manipulation signals to respective target locations 205 and/or to collect one or more collection signals generated by one or more quantum and/or atomic objects located at the target location 205. While FIG. 3 illustrates a portion of the second chip 300 that only includes one transparent conductive window, it should be appreciated that the second chip of various embodiments may include a plurality of transparent conductive windows 360 each including a respective TCF 362 and defined at least in part by a respective window opening 358.

The confinement apparatus chip 200′ comprises a confinement apparatus 202′ including a plurality of electrodes 292 formed on and/or housed by a substrate 290. In various embodiments, the substrate 290 comprises layers similar to those of substrate 206 (e.g., comprising one or more base layers, one or more optical routing layers, and/or the like). In certain embodiments, the substrate 290 comprises one or more electrical routing layers but may not include any optical routing layers.

In various embodiments, the second chip 300 comprises one or more base layers 310, one or more optical routing layers 320, an intermediate conductive layer 330, an insulating layer 340, and a patterned conductive layer 350. The patterned conductive layer 350 is located at and/or defines a delivery surface 370 of the second chip. The delivery surface 370 is a surface of the second chip 300 faces the confinement region 272. In various embodiments, the patterned conductive layer 350 is configured to be a ground plane or a magnetic field generating component.

The one or more base layers 310 may include a wafer or chip substrate (e.g., a silicon wafer, glass substrate, or portion thereof). The one or more base layers 310 may further include one or more electrical routing layers configured for routing electrical signals to the segments 352 of the patterned conductive layer 350 and/or the like (e.g., for grounding of the patterned conductive layer 350, generation of magnetic fields by the patterned conductive layer 350, and/or the like).

In various embodiments, an optical routing layer 320 comprises one or more waveguides 322 each configured to guide one or more guided modes and/or manipulation signals through at least a portion of the second chip 300. The optical routing layer 320 further comprises one or more couplers 324 each in optical communication with a respective waveguide 322 of the one or more waveguides. For example, a coupler 324 may be configured to couple a manipulation signal out of the respective waveguide 322 such that the manipulation signal propagates through a transparent conductive window 360 that is optically aligned with the coupler 324 and is incident at a respective target location 205. In some embodiments, a coupler 324 is configured to receive a collection signal (e.g., photons emitted and/or fluoresced by a quantum and/or atomic object at the target location 205) via the transparent conductive window 360 that is optically aligned with the coupler 324 and then to couple the collection signal into the waveguide 322.

For example, as shown by the dashed arrows, in certain embodiments, a manipulation signal may propagate through the waveguide 322 of the optical routing layer 320, be out-coupled from the waveguide 322 by the coupler 324 and propagate through an aperture 332 in the intermediate conductive layer, through the insulating layer 340, and through a transparent conductive window 360 (e.g., comprising TCF 362 and window opening 358) to be incident at a target location 205. In certain embodiments, a TCF may span at least a portion of the aperture 332. For example, the aperture 332 may comprise a TCF that is in electrical communication with the intermediate conductive layer 330. In various embodiments, the TCF 362 comprises a transparent conductive oxide (TCO) such as indium tin oxide (ITO) and/or the like.

In various embodiment, the coupler 324 is configured to control one or more optical properties of the manipulation signal that is incident on at the target location 205. For example, the coupler 324 may be configured to control the polarization, wavelength/frequency, optical mode, relative phase, focal point, beam dispersion, direction of propagation, and/or other optical properties of the manipulation signal.

In various embodiments, the intermediate conductive layer 330 acts to at least partially shield the confinement region 272 from spurious electric and/or magnetic fields generated within the one or more base layers 310 and/or the optical routing layer 320. For example, the intermediate conductive layer 330 may comprise a layer of a metal or other conductive material that is patterned to include one or more apertures 332 that are optically aligned with respective couplers 324 and transparent conductive windows 360. For example, the apertures 332 are configured to enable manipulation signals and/or collection signals to propagate through the intermediate conductive layer 330. In various embodiments, the patterned conductive layer 350 includes inter-segment openings 354 that separate and/or electrically insulate adjacent segments 352 from one another. In various embodiments, the intermediate conductive layer 330 is configured to prevent electric fields generated within the one or more base layers 310 and/or one or more optical routing layers 320 from reaching the confinement region 272 through the inter-segment openings 354. For example, the one or more apertures 332 of the intermediate conductive layer 330 are not aligned with the inter-segment openings 354.

In various embodiments, the insulating layer 340 is a dielectric layer configured to electrically insulate the patterned conductive layer 350 from the optical routing layer(s) 320 and, possibly, from the base layer(s) 310. In various embodiments, gaps 344 may be etched into the insulating layer 340 beneath the inter-segment openings 354. In various embodiments, the second chip 300 may include various layers between the optical routing layer 320 and the patterned conductive layer 350 as an alternative and/or in addition to the intermediate conductive layer 330 and/or insulating layer 340.

In various embodiments, the patterned conductive layer 350 comprises a plurality of segments 352 patterned out of a conductive and/or metal material. The patterned conductive layer 350 defines a delivery surface 370 of the second chip 300. The delivery surface 370 is the surface of the second chip 300 that faces the confinement region 272 defined by the confinement apparatus 202′ house by the confinement apparatus chip 200'. In various embodiments, the segments 352 of the patterned conductive layer 350 are configured to provide a ground plane and/or to generate a magnetic field and/or magnetic field gradient at the confinement region 272.

In various embodiments, the patterned conductive layer 350 includes inter-segment openings 354 and window openings 358. In certain embodiments, the patterned conductive layer 350 includes one or more load hole openings 382. In various embodiments, a load hole 380 is a through hole through the second chip 300 configured to enable loading of quantum and/or atomic objects into the confinement apparatus 202. In various embodiments, the segments 352 of the patterned conductive layer 350 overhang the inter-segment openings 354 and/or load hold openings 382. For example, an overhang portions 356 of segments extend over the gaps 344 and/or load hole 380.

In various embodiments, the window opening defines an opening area in a plane parallel to the delivery surface 370 and/or the confinement region 272, similar to as shown in FIG. 2A. The TCF 362 defines a window area in a plane parallel to the delivery surface 370 and/or the confinement region 272. The window area is larger than the opening area. For example, the TCF 362 extends under the segment 352C in which the window opening 358 is located. For example, the TCF extends under the segment 352C beyond the edges of the window opening 358.

The TCF 362 is in electrical communication with the segment 352C within which the window opening 358 is located. For example, the contact portion of the TCF 362 is in electrical contact (e.g., in direct physical contact and/or is in contact via an electrically conductive material) with the segment 352C. The contact portion of the TCF 362 (e.g., the portion of the window area that does not correspond and/or is not aligned with the opening area). In various embodiments, the TCF 362 is in electrical communication with the segment 352C in which the window opening 358 is located such that an electrical resistance between the TCF 362 of the transparent conductive window 360 and the at least a portion of the patterned conductive layer (e.g., the segment 352C) is no more than 200 ohms. In some embodiments, the electrical resistance between the TCF 362 and the segment 352C is less than 100 ohms, less than 50 ohms, less than 10 ohms, or less than 6 ohms.

While overhang portions 256, 356 improve the functioning of the confinement apparatus 202 and/or the confinement apparatus assembly 90 (e.g., by providing further shielding of the confinement region 272 from electric fields generated by build-up of electric charge in the insulating layer 240, 340 and/or in other layers of the substrate 206 or the second chip 300) they add complexity to the fabrication of the confinement apparatus chip 200 and/or second chip 300. For example, the complicated and/or non-planar topology of the delivery surface 270, 370 makes fabrication of the TCF as a final step very difficult. Additionally, it is expected that TCF fabricated as a final step in the confinement apparatus chip or second chip fabrication would provide a high electrical resistance between the TCF and the segment with which the TCF is in electrical communication, which would cause substantial heating of quantum and/or atomic objects confined at the confinement region 272. Thus, various embodiments provide substantial technical improvements to the field of confinement apparatus assemblies including transparent conductive windows.

### Example Methods of Fabricating a Chip of a Confinement Apparatus Assembly Including at

least one Transparent Conductive Window

Various embodiments provide atomic object assemblies where the atomic object assembly includes at least one chip (e.g., a confinement apparatus chip and/or a second chip) that includes at least one transparent conductive window comprising a TCF that is disposed between a segment of the patterned conductive layer and an insulating layer of the chip. In other words, the TCF is fabricated while there are still additional, remaining, and/or subsequent processes to be performed to complete fabrication of the chip hosting the TCF.

When the TCF(s) of one or more transparent conductive windows of a confinement apparatus assembly are fabricated prior to patterning of a patterned conductive layer 250, 350, and/or prior to performance of one or more additional and/or remaining processes of the fabrication of the chip (e.g., undercut etches to fabricate gaps 244, 344, load hole etches to fabricate load holes 280, 380, patterned conductive layer clean-up, die singulation, and/or the like), the TCF(s) may be damaged and/or saturated with oxygen (or other element and/or chemical). This may result in the TCF having reduced electrical conductivity, increased electrical resistance, reduced optical transparency, and/or the like. Various embodiments provide methods for fabricating a confinement apparatus assembly including a chip (e.g., a confinement apparatus chip or a second chip configured to be secured with respect to the confinement apparatus chip) that includes at least one TCF of one or more transparent conductive windows where the TCF is fabricated prior to the patterning of the patterned conductive layer and/or prior to performance of one or more additional and/or remaining processes. Some embodiments include processes and/or procedures for protecting the TCF of a transparent conductive window during performance of integrated fabrication operations. Some embodiments include processes and/or procedures for repairing the TCF of a transparent conductive window that occurs during performance of integrated fabrication operations.

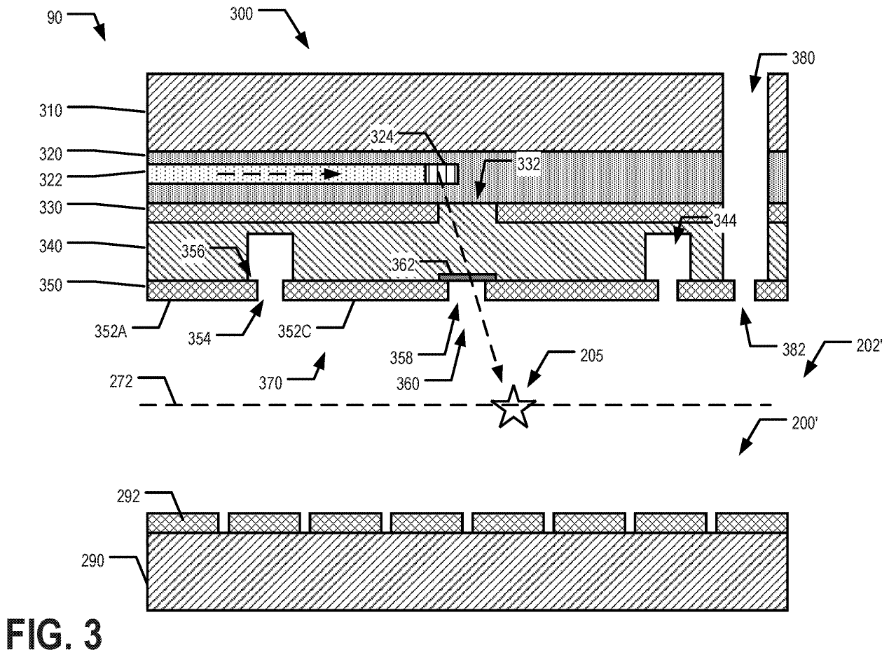

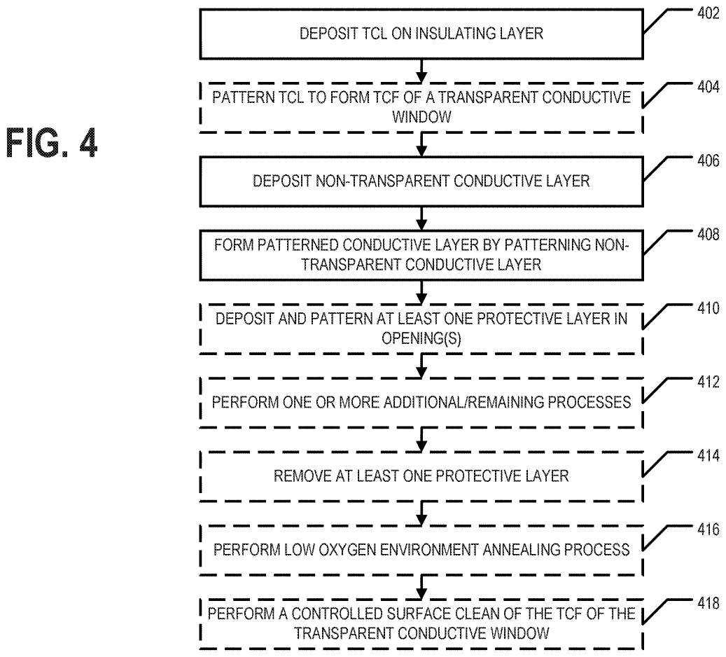

In various embodiments, a transparent conductive layer (TCL) is deposited. The TCL may be patterned into TCFs before or after the depositing and patterning of a non-transparent conductive layer thereon. In some embodiments, the TCL may be patterned to form one or more TCFs including nano-structures (e.g., patterned metal nanostructures). For example, a TCF may be a composite conductive layer, in certain embodiments. In various embodiments, the non-transparent conductive layer is patterned using various patterning techniques such as etching (e.g., lithographic etch, direct write, and/or the like), lift-off processes, damascene processes, and/or the like. In some embodiments, one or more protect layers are deposited on the TCL and/or TCF(s) to protect the TCL and/or TCF(s) during depositing and patterning of the non-transparent conductive layer and/or other fabrication steps. The one or more protect layers may be un-patterned or may be patterned at various points during the fabrication process (e.g., before depositing of the non-transparent conductive layer, after patterning of the non-transparent conductive layer, and/or the like). Some example sequences of fabrication processes are described with respect to FIGS. 4-14F . As should be understood, various other sequences of the fabrication processes may be used in various embodiments, as appropriate for the application.

FIG. 4 provides a flowchart illustrating various processes and/or procedures for fabricating a chip of a confinement apparatus assembly (e.g., a confinement apparatus chip and/or a second chip configured to be secured into a particular relationship with the confinement apparatus chip. Starting at step 402, a transparent conductive layer (TCL) is deposited onto an insulating layer. The insulating layer is part of a substrate including an optical routing layer. The optical routing layer includes at least one waveguide.

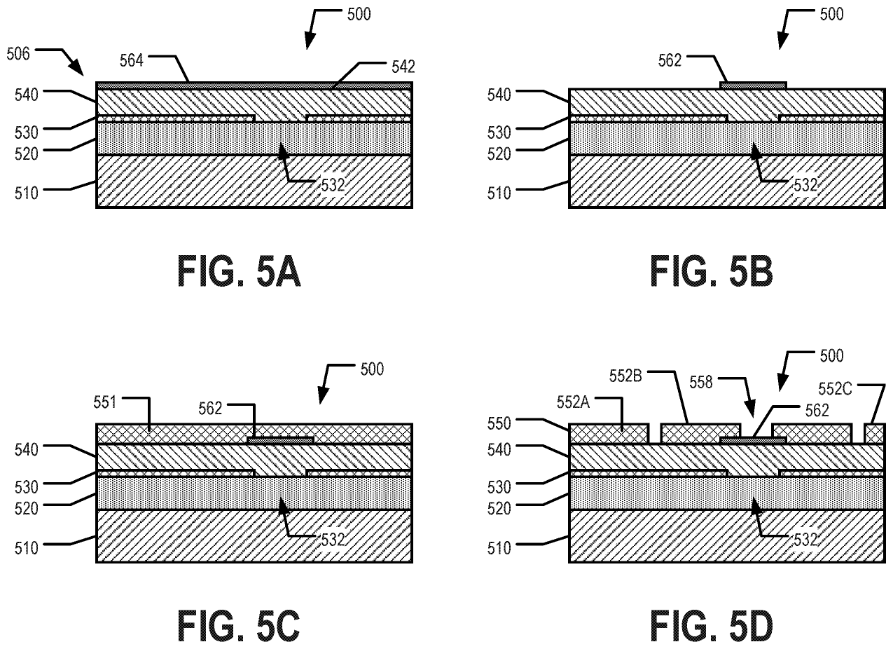

For example, FIG. 5A illustrates a partially fabricated chip 500 that includes a TCL 564 deposited on an insulating layer 540. The partially fabricated chip 500 includes a substrate 506 that includes an optical routing layer 520 that comprises at least one waveguide (not shown) and may further include at least one coupler configured to couple manipulation signals out of the at least one waveguide and/or collection signals into the at least one waveguide. The illustrated substrate 506 includes the insulating layer 540, an intermediate conductive layer 530, one or more optical routing layers 520, and one or more base layer 510.

The one or more base layers 510 may include a wafer or chip substrate (e.g., a silicon wafer or portion thereof). The one or more base layers 510 may further include one or more electrical routing layers configured for routing electrical signals to the segments of the patterned conductive layer to be fabricated on the substrate 506, and/or the like.

In various embodiments, an optical routing layer 520 comprises one or more waveguides each configured to guide one or more guided modes and/or manipulation signals through at least a portion of the chip. The optical routing layer 520 further comprises one or more couplers each in optical communication with a respective waveguide of the one or more waveguides. For example, a coupler may be configured to couple a manipulation signal out of the respective waveguide such that the manipulation signal propagates through a transparent conductive window that is optically aligned with the coupler and is incident at a respective target location 205. In some embodiments, a coupler is configured to receive a collection signal (e.g., photons emitted and/or fluoresced by a quantum and/or atomic object at the target location 205) via a transparent conductive window that is optically aligned with the coupler and then to couple the collection signal into the waveguide.

In various embodiments, the intermediate conductive layer 530 acts to at least partially shield from spurious electric and/or stray light that may be generated within the one or more base layers 510 and/or the optical routing layer 520. For example, the intermediate conductive layer 530 may comprise a layer of a metal or other conductive material that is patterned to include one or more apertures 532 that are optically aligned with respective couplers of the optical routing layer(s) 520.

In various embodiments, the insulating layer 540 is a dielectric layer configured to electrically insulate the patterned conductive layer to be fabricated on the substrate 506 from the optical routing layer(s) 520 and, possibly, from the base layer(s) 510. In various embodiments, the surface 542 of the insulating layer 540 onto which the TCL 564 is deposited is a substantially planar surface when the TCL 564 is deposited thereon.

In various embodiments, the TCL comprises a transparent conductive oxide (TCO), such as indium tin oxide (ITO), aluminum doped ZnO and/or the like. In various embodiments, the TCL is deposited using a sputtering technique, atomic layer deposition (ALD), physical vapor deposition (PVD), chemical vapor deposition (CVD), and/or the like. In various embodiments, the TCL 564 is a thin layer. For example, the TCL may have a thickness in a direction perpendicular the substantially planar surface 542 in a range of 1 nm to 10 microns (e.g., 10-40 nm in an example embodiment; approximately 50 nm in one embodiment; approximately 500 nm in another embodiment).

Returning to FIG. 4, in some embodiments, at step 404, the TCL 564 is patterned to form one or more transparent conductive films (TCFs), where each TCF corresponds to and/or is to be part of a respective transparent conductive window. Each TCF is optically aligned with at least one coupler of the optical routing layer. For example, a lithographic pattern and etch or other mask and etch processes (e.g. shadow mask or hard mask) may be used to etch the TCL 564 to pattern and/or define one or more TCFs. FIG. 5B illustrates the partially fabricated chip 500 after the TCL 564 has been patterned to form and/or define a TCF 562 therefrom.

In some embodiments, the TCL 564 is not patterned until after deposition of the non-transparent conductive layer. In such embodiments, the TCL 564 may be patterned to form the TCF simultaneously or after the patterning of the non-transparent conductive layer. For example, in some embodiments, a TCF 562 is present between each electrode or segment of the patterned conductive layer and the insulating layer across the entire surface area of the electrode or segment of the patterned conductive layer (e.g., an electrode or segment of the patterned conductive layer may not be in direct physical contact with the insulating layer but may be in physical contact with the insulating layer via the TCF 562).

In certain embodiments where the non-transparent conductive layer is patterned using a lift-off technique, the TCFs may be patterned and/or a lift off layer may be deposited and patterned (e.g., with lithography) before the non-transparent conductive layer is deposited. In certain embodiments where the non-transparent conductive layer is patterned using a damascene technique, a mask (e.g., an oxide mask) may be deposited and patterned (e.g., using an appropriate etch technique) prior to the deposition of the non-transparent conductive layer.

Continuing with FIG. 4, at step 406, a non-transparent conductive layer is deposited onto the partially fabricated chip (e.g., onto the TCF 564 and the exposed portion of the surface 542 of the insulating layer 540). In various embodiments, the non-transparent conductive layer comprises a metal (e.g., copper, aluminum, gold, silver, platinum, titanium, niobium, and/or the like or an alloy thereof). In various embodiments, the non-transparent conductive layer is deposited using a sputtering technique, atomic layer deposition (ALD), an evaporation technique (e.g., thermal or electron beam evaporated), physical vapor deposition (PVD), chemical vapor deposition (CVD), and/or the like.

FIG. 5C illustrates the partially fabricated chip 500 after deposition of the non-transparent conductive layer 551. Notably, the TCF 562 is disposed between the insulating layer 540 and the non-transparent conductive layer 551.

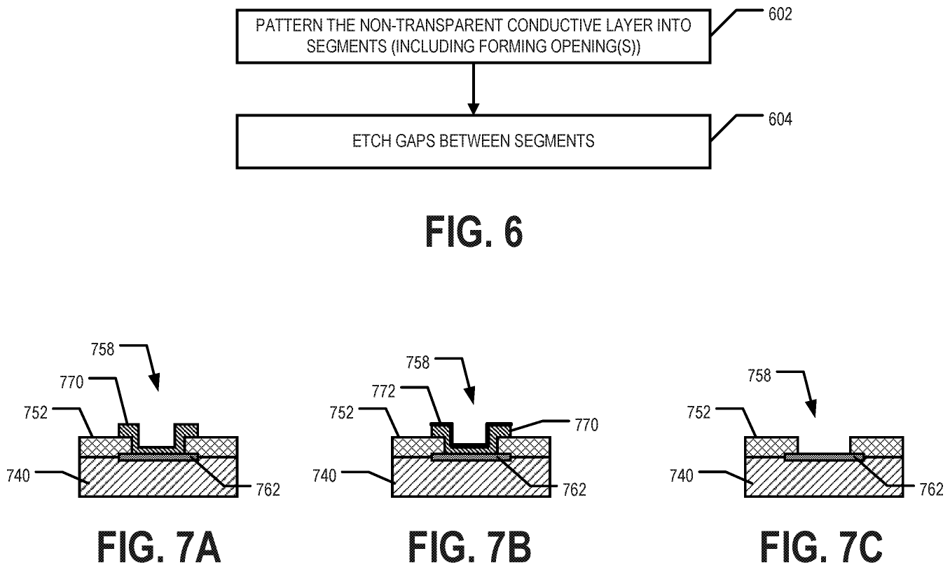

Continuing with FIG. 4, at step 408, the non-transparent conductive layer is patterned to form the patterned conductive layer. FIG. 6 provides a flowchart illustrating various processes and/or procedures that may be performed as part of patterning a non-transparent conductive layer to form a patterned conductive layer. Starting at step 602, the non-transparent conductive layer is etched to pattern the non-transparent conductive layer into a plurality of segments. For example, the non-transparent conductive layer may be etched to define a plurality of segments of a patterned conductive layer. In some embodiments, patterning the non-transparent conductive layer includes etching the window openings through the non-transparent conductive layer. For example, an etch may be performed that is configured to etch through the non-transparent conductive layer to define a plurality of segments and window openings of the patterned conductive layer. In various embodiments, patterning the non-transparent conductive layer to form a patterned conductive layer comprises performing at least one of metal liftoff patterning, direct etch patterning, or damascene patterning. In various embodiments, the non-transparent conductive layer is patterned to define a plurality of segments that may be spatially separated and/or electrically insulated from one another and one or more window openings within a respective segments.

For example, as shown in FIG. 5D, the non-transparent conductive layer 551 may be etched to define segments 552 (e.g., 552A, 552B, 552C). of the patterned conductive layer 550. Some of the segments, such as segment 552B), may have window openings 558 etched therethrough. For example, patterning the non-transparent conductive layer 551 may include etching the non-transparent conductive layer 551 to define individual segments 552 that are electrically isolated from one another and to etching window openings 558 that are optically aligned with the TCFs 564 of the partially fabricated chip 500. For example, at least a portion of a TCF 564 may be exposed via etching performed to pattern the non-transparent conductive layer 551 to form the patterned conductive layer 550.

However, even though at least a portion of a TCF 564 is now exposed, the partially fabricated chip 500 is still only partially fabricated. For example, undercut etchings may be performed to form gaps 244, 344 between adjacent segments 552 of the patterned conductive layer 550, load holes may be etched through the chip, clean up processes (e.g., an O₂ plasma clean and/or other processes configured to remove contaminants and/or residual particles from the exposed surfaces of the partially fabricated chip 500) may be performed to clean up the patterned conductive layer 550, a die on which the chip was formed may be separated into multiple chips via die singulation, and/or the like.

Continuing to step 604 of FIG. 6, gaps may be etched between adjacent segments. For example, gaps similar to gaps 244, 344 may be etched into an insulating layer such that the adjacent segments overhang each of the gaps, as shown in FIGS. 2 and 3. In various embodiments, the gaps are etched using a wet and/or chemical selective etch. In some embodiments, the gaps are etched as part of the one or more additional processes (e.g., as part of step 412) rather than as part of step 408.

Returning to FIG. 4, in some embodiments, at step 410, at least one protective layer is deposited and patterned within one or more window openings. The at least one protective layer protects the TCF from damage and/or from being exposed to oxygen or other chemicals that may saturate the TCF and/or negatively affect the electrical and/or optical properties of the TCF. For example, the at least one protective layer includes at least one sacrificial layer of material that is patterned over the TCF. The at least one sacrificial layer is inert or robust to subsequent process of fabricating the chip. For example, the at least one sacrificial layer is configured to remain intact and present through the performance of one or more additional processes (e.g., undercut etching, load hole etching, clean up processes, die singulation, wafer bonding, die bonding, bump-bonding, chip packaging, and/or the like).

In certain embodiments, the at least one protective layer consists of a primary protective layer. FIG. 7A illustrates a cross-sectional view of a portion of a chip having an example of a primary protective layer 770 deposited and patterned within a window opening 758. A TCF 762 is disposed between an insulating layer 740 and a segment 752 of a patterned conductive layer. The window opening 758 is etched through the segment 752. A primary protective layer 770 has been deposited and patterned in the window opening 758. In various embodiments, the primary protective layer 770 may be deposited using a sputtering technique, an evaporation technique (e.g., thermal or electron beam evaporation), atomic layer deposition (ALD), physical vapor deposition (PVD), chemical vapor deposition (CVD), and/or the like. In various embodiments, the primary protective layer 770 is patterned using a patterned etch, such as a lithographic pattern and etch, for example, or a shadow mask. various embodiments, the primary protective layer 770 may be strippable or removeable using a wet and/or chemically selective etch that substantially does not affect other materials of the chip. For example, the primary protective layer 770 may be strippable or removeable using a wet and/or chemically selective etch that substantially does not affect the material of the patterned conductive layer, TCF, or insulating layer.

In certain embodiments, a wet and/or chemically selective etch does not substantially affect a material because the etch rate of the material is slow (e.g., at least two times slower, for example) via the wet and/or chemically selective etch compared to the target material of the wet and/or chemically selective etch. In another example, a wet and/or chemically selective etch may oxidize a material and the wet and/or chemically selective etch does not substantially affect the material because the oxide/dielectric formed during the etch is thin (e.g., less than 10 nm thick, for example). In another example, a wet and/or chemically selective etch may change the doping and/or resistivity of a TCF material and the wet and/or chemically selective etch does not substantially effect the TCF material because resistivity of the TCF material changes by a small percentage of the original resistivity (e.g., less than 10%, for example) as a result of the etch.

In certain embodiments, the primary protective layer 770 comprises W, TiW, Ge, TiN and/or the like. In various embodiments, the primary protective layer 770 is deposited and patterned prior to performance of subsequent processing (e.g., undercut etching, load hole etching, clean up processes, die singulation, and/or the like).

In certain embodiments, the at least one protective layer includes a primary protective layer and a secondary protective layer. FIG. 7B illustrates and example of a primary protective layer 770 and a secondary protective layer 772 deposited and patterned within a window opening 758. For example, the primary protective layer 770 may be deposited and patterned into the window opening 758 and then the secondary protective layer 772 may be deposited and patterned into the window opening 758 and/or onto the primary protective layer 770. In various embodiments, the secondary protective layer 772 may comprise a plurality of layers of one or more materials. For example, the secondary protective layer 772 may comprise a plurality of films.

In various embodiments, the primary protective layer 770 may be deposited using a sputtering technique, an evaporation technique (e.g., thermal or electron beam evaporation), atomic layer deposition (ALD), physical vapor deposition (PVD), chemical vapor deposition (CVD), and/or the like. In various embodiments, the primary protective layer 770 is patterned using a patterned etch, such as a lithographic pattern and etch, for example, or a shadow mask. In various embodiments, the secondary protective layer 772 may be deposited using a sputtering technique, an evaporation technique (e.g., thermal or electron beam evaporation), atomic layer deposition (ALD), physical vapor deposition (PVD), chemical vapor deposition (CVD), and/or the like. In various embodiments, the secondary protective layer 772 is patterned using a patterned etch, such as a lithographic pattern and etch, for example, or a shadow mask.

In various embodiments, the secondary protective layer 772 is configured to protect the primary protective layer 770 during the performance of one or more additional processes. For example, the primary protective layer 770 may not be fully inert to at least one process of the one or more additional processes. The secondary protective layer 772 may be selected to be sufficiently inert to the one or more additional processes such that the secondary protective layer 772 protects the primary protective layer 770 during performance of the one or more additional processes. In various embodiments, the secondary protective layer 772 is strippable or removeable using a dry etch using the primary protective layer 770 as an etch stop. In certain embodiments, the primary protective layer 770 comprises W, Ge, TiN, and/or TiW and the secondary protective layer 772 comprises Si, amorphous Si (aSi), SiO₂, SiO₂, Al, Ti and/or TiO₂, Au, Pt, TiN, spin on glass, and/or another material.

Returning to FIG. 4, at step 412, one or more additional or remaining processes are performed. In various embodiments, the one or additional processes may include undercut etchings to form gaps between adjacent segments of the patterned conductive layer, etching load holes, performing clean up processes (e.g., an O₂ plasma clean and/or the like) may be performed to clean up the patterned conductive layer and/or other portions/components of the chip, die singulation, wafer bonding, die bonding, bump-bonding, chip packaging, and/or the like. For example, after the TCF(s) have been exposed, and possibly protected via at least on protective layer, one or more additional processes may be performed to complete fabrication of the chip.

At step 414, in examples where at least one protective layer was deposited and patterned at step 410, the at least one protective layer is removed. For example, if a secondary protective layer 772 was deposited and patterned, the secondary protective layer 772 is removed using a dry etch, in certain embodiments. In another example, if a primary protective layer 770 was deposited and patterned, the primary protective layer 770 is removed using a wet and/or chemical selective etch, in certain embodiments, that substantially does not affect and/or interact with other materials of the chip (e.g., the patterned conductive layer, insulating layer, TCF, and/or the like). FIG. 7C illustrates a cross-section of a portion of a chip after the secondary protective layer 772 and/or primary protective layer 770 are removed from the window opening 758 such that the TCF 762 is again exposed.

For example, the non-transparent conductive layer can be aluminum or an alloy containing aluminum and other elements. The patterning of the transparent conductive layer gaps and windows-may be performed using a chlorine-based dry plasma etch. The chlorine-based dry plasma etch may also be used to (simultaneously) patterned a secondary protective layer 772 comprising SiO2, for example, or a protective layer including TiN, for example. For example, a chlorine-based dry plasma etch may be used as a chemical selective etch to pattern a non-transparent conductive layer to form a patterned non-transparent conductive layer and to remove a (secondary) protective layer.

In an example embodiment, the secondary protect layer 772 comprises SiO₂ and removing the secondary protect layer 772 is performed using a selective wet oxide etch, for example including buffered hydrofluoric acid (HF). In an example embodiment, the secondary protect layer 772 comprises TiN and removing the secondary protect layer 772 is performed with a standard wet clean, using hydrogen peroxide, for example.

Continuing with FIG. 4, in some embodiments, during performance of the one or more additional processes, the TCF may become saturated with oxygen or another chemical. For example, the one or more additional processes may include an O₂ plasma cleaning. If at least one protective layer is not deposited and patterned in the window opening to protect the TCF, the TCF may become saturated with oxygen during the O₂ plasma cleaning. Therefore, in some embodiments, at step 416, an annealing may be performed in a low oxygen environment. For example, an annealing process in a low oxygen environment may be performed to cause oxygen to be released by the TCF such that the resistance and/or optical transmission of the TCF is returned to close to the original, as-deposited performance of the TCF. For example, in certain embodiments, after performance of the one or more additional processes, a low oxygen environment annealing process is performed to cause oxygen to be released from the TCF(s) of the one or more transparent conductive windows of the chip.

In various embodiments, the annealing process comprises heating the chip to a temperature between 250 and 500 degrees Celsius for a time of at least half an hour. In an example embodiment, the annealing process is performed for up to 48 hours. For example, the annealing process is performed at a temperature that will not affect the other components of the chip (e.g., the segments of the patterned conductive layer, the electrical routing layer(s), the insulating layer(s), the waveguide and couplers of the optical routing layer(s), and/or the like). In various embodiments, the annealing process comprises heating the chip to a temperature between 300 and 400 degrees Celsius for a time in a range of one hour (at least an hour and a half, in some embodiments) to five hours.

In various embodiments, the low oxygen environment is one of a vacuum environment or an environment having a gas flow of a gas that substantially does not include oxygen. For example, the anneal may be performed in an environment that has a reduced oxygen content (e.g., compared to air). The reduced oxygen content of the low oxygen environment may be achieved via a vacuum environment or via an environment having a as flow of a gas that substantially does not include oxygen (e.g., a generally inert gas and/or other gas not including oxygen such as a reducing atmospheres such as forming gas, for example).

At step 418, a controlled surface clean of the TCF(s) of one or more transparent conductive windows of the chip is performed. For example, a plasma, milling, or mechanical buffing may be used to perform a controlled surface clean up. For example, in certain embodiments, one to ten atomic layers of the TCF may be removed via a controlled surface clean. For example, damaged or oxygen saturated atomic layers of the TCF may be removed such that the electrical and/or optical properties of the TCF may be improved (e.g., compared to a damaged or saturated state prior to the controlled surface clean).

In some embodiments, the completed chip (e.g., a confinement apparatus chip 200) is a completed confinement apparatus assembly 90. In some embodiments, once a chip is fabricated, the chip may be incorporated into a confinement apparatus assembly 90. For example, the confinement apparatus assembly 90 may include securing a second substrate or chip 300 into a set relationship with a confinement apparatus 202, 202′ hosted by a confinement apparatus chip 200, 200′.

In various embodiments, the TCL is deposited onto a substantially planar surface 542 of the insulating layer 540 of the substrate 506. The TCL is then patterned to form one or more TCFs. Conventionally, patterning of the TCL to form the one or more TCFs is performed using a wet etch. However, the wet etch may result in laterally over-etching the TCL. The over-etching of the TCL may change the resulting dimensions of the TCF from the planned dimensions such that unshielded dielectrics of the insulating layer may be exposed via the window opening corresponding to the TCF. When a dry etch is used to pattern the TCL, the etching may extend into the insulating layer (e.g., the oxide scaffold provided by the insulating layer), which can result in ion to photonic beam misalignment.

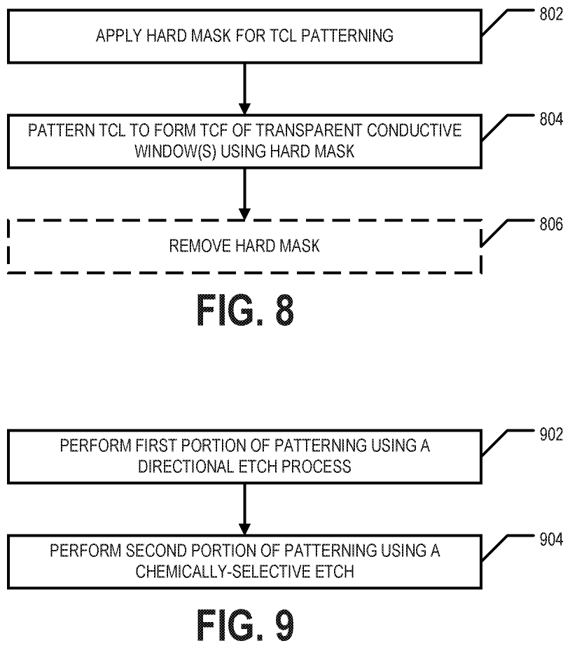

FIGS. 8 and 9 provide flowcharts illustrating two example methods for patterning the TCL to form the TCF(s) in a manner that prevents the over-etching of the TCL. FIG. 8 illustrates a method where, to prevent the over-etching of the TCL during the TCL patterning process, a hard-mask patterning process is used instead of the conventional lithography masked, wet etching process.

Starting with step 802 of FIG. 8, a hard mask is applied to the TCL for patterning of the TCL into one or more TCFs. At step 804, the TCL is patterned to form the TCF(s) of the one or more transparent conductive windows of the chip using the hard mask. At step 806, the hard mask is removed from the TCF(s). The TCF(s) may then be ready for deposition of the non-transparent conductive layer (and/or one or more protective layers) thereon.

FIG. 9 illustrates a method where, to prevent lateral over-etching of the TCL patterns and over-etching of the scaffold during the TCL patterning process, a dry etch is used to remove the bulk of the TCL to be removed and a short wet etch is then performed to finish patterning of the TCL into TCFs without over-etching into the supporting scaffold of the insulating layer.

Starting at step 902, a first portion of a patterning process for patterning the TCL to form and/or define one or more TCFs is performed using a directional etch process. For example, the first portion of the patterning process may include performing 10-90% of the patterning etch. For example, in areas of the TCL to be removed 10-90% of the thickness of the TCL is removed via a directional etch. In an example embodiment, the first portion of the patterning process may include performing 75-95% of the patterning etch. In an example embodiment, the directional etch is a dry etch.

At step 904, a second portion of the patterning process for patterning the TCL to form and/or define the one or more TCFs is performed using a chemically-selective etch process. For example, the second portion of the patterning process may include performing 10-90% of the patterning etch. For example, in areas of the TCL to be removed 10-90% of the thickness of the TCL is removed via a chemically-selective etch. In an example embodiment, the first portion of the patterning process may include performing 5-25% of the patterning etch. For example, the chemically-selective etch used to perform the second portion of the patterning process may be short enough that the chemically-selective etch does not have time to perform lateral over-etching of the TCL such that the resulting dimensions of the TCF are within fabrication tolerances of the planned dimensions. In an example embodiment, the chemically-selective etch is a wet etch.

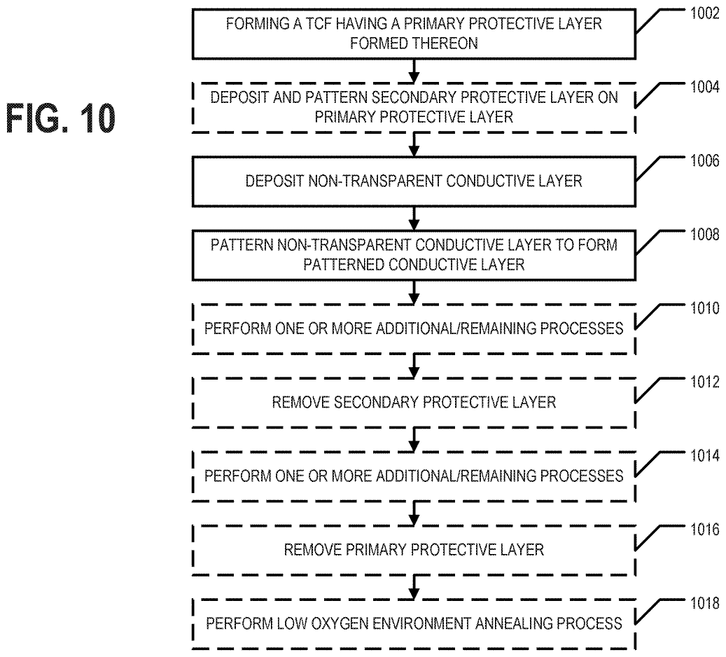

FIG. 10 provides a flowchart illustrating various processes and/or procedures for fabricating a chip (e.g., a confinement apparatus chip 200 and/or a second chip 300) using one or more protective layers that are deposited prior the deposition of the non-transparent conductive layer, according to another example embodiment.

Starting at step 1002, a TCF is formed having a primary protective layer formed thereon. In various embodiments, the TCF is formed on a substantially planar surface of an insulating layer. For example, as shown in FIG. 12A, at least one TCF 1262 is formed on a substantially planar surface 1242 of an insulating layer 1240 of a chip (e.g., confinement apparatus chip 200 and/or second chip 300). A primary protective layer 1270 is formed on the TCF 1262.

In various embodiments, the TCF 1262 comprises a TCO, such as ITO and/or the like. In various embodiments, the primary protective layer 1270 may be strippable or removeable using a wet and/or chemically selective etch that substantially does not affect other materials of the chip. For example, the primary protective layer 1270 may be strippable or removeable using a wet and/or chemically selective etch that substantially does not affect the material of the patterned conductive layer, TCF, or insulating layer. In certain embodiments, the primary protective layer 1270 comprises W, TiW, Ge, TiN and/or the like.

In various embodiments, the primary protective layer defines a primary protective area. In an example embodiment, the primary protective layer comprises an electrically conductive material, the primary protective area is larger than, equal to, or less than the window area. In an example embodiment, the primary protective layer is not electrically conductive and the primary protective area is less than the window area.

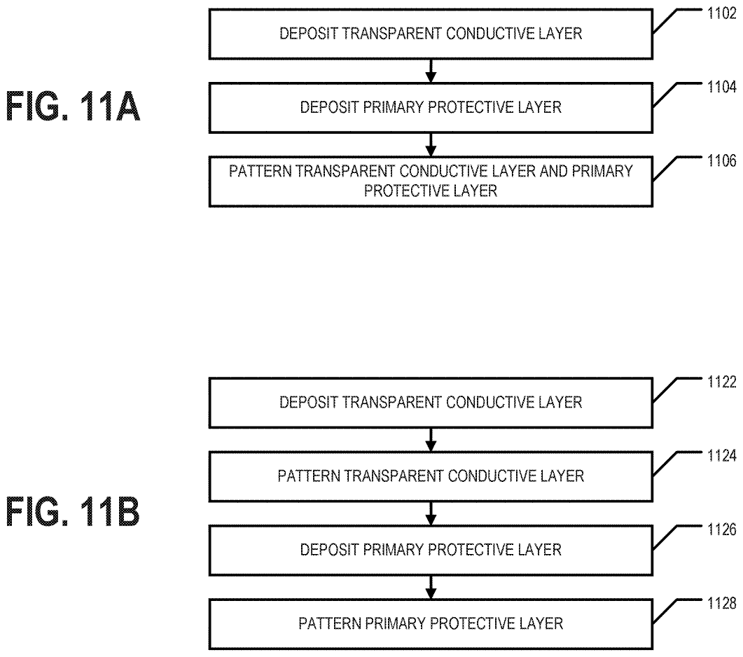

FIGS. 11A and 11B provide respective flowcharts illustrating various processes and/or procedures of two example methods for forming one or more TCFs having respective primary protective layers formed thereon. For example, starting with step 1102 of FIG. 11A, a TCL is deposited on the substantially planar surface of the insulating layer. In various embodiments, the TCL is deposited using a sputtering technique, an evaporation technique (e.g., thermal or electron beam evaporation), atomic layer deposition (ALD), physical vapor deposition (PVD), chemical vapor deposition (CVD), and/or the like. In various embodiments, the TCL is a thin layer. For example, the TCL may have a thickness in a direction perpendicular the substantially planar surface in a range of 1 nm to 10 microns (e.g., 10-40 nm, 50 nm, or 500 nm, in various embodiments depending on the material of the TCL). In various embodiments, the patterning of the TCL and/or the first primary protective layer may be performed using lithographic process, damascene processes, or other appropriate patterning processes. In some embodiments, the TCL and/or the first primary protective layer is not patterned until after deposition of the conductive non-transparent layer.

At step 1104, the primary protective layer is deposited on the TCL. In various embodiments, the primary protective layer may be deposited using sputtering technique, atomic layer deposition (ALD), physical vapor deposition (PVD), chemical vapor deposition (CVD), and/or the like.

At step 1106, the TCL and primary protective layer is patterned to define one or more TCFs having respective primary protective layer formed thereon. For example, in certain embodiments, a wet and/or selective chemical etch may be used to pattern the primary protective layer and a different wet or chemically selective etch or a method in accordance with one of FIG. 8 or FIG. 9 may be used to pattern the TCL to form the TCF(s). In an example embodiment, the primary protective layer and the TCL are patterned using a dry etch to define the TCF having the primary protective layer formed thereon.

FIG. 11B provides an alternative method for forming a TCF having a primary protective layer formed thereon. Starting at step 1122, a TCL is deposited on the substantially planar surface of the insulating layer. In various embodiments, the TCL is deposited using a sputtering technique, atomic layer deposition (ALD), physical vapor deposition (PVD), chemical vapor deposition (CVD), and/or the like. In various embodiments, the TCL is a thin layer. For example, the TCL may have a thickness in a direction perpendicular the substantially planar surface in a range of 1 nm to 10 microns (e.g., 10-40 nm, 50 nm, or 500 nm, in various embodiments depending on the material of the TCL).

At step 1124, the transparent conductive layer is patterned to form one or more TCFs. In various embodiments, a wet or chemically selective etch or a method in accordance with one of FIG. 8 or FIG. 9 may be used to pattern the TCL to form the TCF(s).

At step 1126, the primary protective layer is deposited on the TCF(s) and the surface of the insulating layer. In various embodiments, the primary protective layer may be deposited using sputtering technique, atomic layer deposition (ALD), physical vapor deposition (PVD), chemical vapor deposition (CVD), and/or the like.

At step 1128, the primary protective layer is patterned to form the respective primary protective layers on the one or more TCFs. In various embodiments, the primary protective layer is patterned using a wet or selective chemical etch that is inert and/or does not affect the TCF(s).

Returning to FIG. 10, at step 1004, in some embodiments, a secondary protective layer is deposited onto the primary protective layer, any exposed surface portion of the TCF, and the exposed surface portion of the insulating layer. The secondary protective layer is patterned to define respective secondary protective layer portions disposed on the first protective layer formed on the one or more TCFs. For example, the secondary protective layer corresponding to a TCF may define a second protective area that is less than the window area of the corresponding TCF. For example, FIG. 12B illustrates a secondary protective layer 1272 patterned onto primary protective layer 1270 that is formed on a TCF 1262. The secondary protective layer 1272 may not completely cover the primary protective layer 1270. In various embodiments, the secondary protective layer 1272 may comprise a plurality of layers of one or more materials. For example, the secondary protective layer 1272 may comprise a plurality of films.

In various embodiments, the secondary protective layer 1272 is strippable or removeable using a dry etch using the primary protective layer 1270 as an etch stop. In certain embodiments, the primary protective layer 1270 comprises W, Ge, TiN, and/or TiW and the secondary protective layer 1272 comprises Si, amorphous Si (aSi), SiO₂, Al, Ti and/or TiO₂, Au, Pt, TiN, spin on glass, and/or another material. In various embodiments, the secondary protective layer 1272 may be deposited using a sputtering technique, atomic layer deposition (ALD), physical vapor deposition (PVD), chemical vapor deposition (CVD), and/or the like. In various embodiments, the secondary protective layer 1272 is patterned using a patterned (dry) etch, with a lithographic mask, for example.

In various embodiments, the secondary protective layer 1272 is configured to protect the primary protective layer 1270 during the performance of one or more additional and/or remaining processes. For example, the primary protective layer 1270 may not be fully inert to at least one process of the one or more additional processes. The secondary protective layer 1272 may be selected to be sufficiently inert to the one or more additional and/or remaining processes such that the secondary protective layer 1272 protects the primary protective layer 1270 during performance of the one or more additional or remaining processes.

Continuing with FIG. 10, at step 1006, a non-transparent conductive layer is deposited. For example, the non-transparent conductive layer is deposited on the secondary protective layer, any exposed portion of the first protective layer, any exposed portion of the TCF, and/or the exposed portion of the insulating layer. In various embodiments, the non-transparent conductive layer comprises a metal that is deposited via a sputtering technique, atomic layer deposition (ALD), physical vapor deposition (PVD), chemical vapor deposition (CVD), and/or the like. FIG. 12C illustrates a non-transparent conductive layer 1251 deposited onto a secondary protective layer 1272, primary protective layer 1270 (which is covering and/or protecting the TCF 1262), and the insulating layer 1240.

Continuing with FIG. 10, at step 1008, the non-transparent conductive layer is patterned to form the patterned conductive layer. For example, the non-transparent conductive layer may be etched to define segments of the patterned conductive layer with at least one segment including a window opening etched therethrough. For example, the non-transparent conductive layer may be patterned in accordance with the method illustrated by FIG. 6. For example, FIG. 12D illustrates the non-transparent conductive layer 1251 etched to define a segment 1252 of a patterned conductive layer and having a window opening 1258 etched therethrough. In various embodiments, the etching of the non-transparent conductive layer uses the secondary protective layer as an etch stop.

Returning to FIG. 10, at step 1010, one or more additional or remaining processes are performed. In various embodiments, the one or additional processes may include undercut etchings to form gaps between adjacent segments of the patterned conductive layer, etching load holes, performing clean up processes (e.g., an O₂ plasma clean and/or the like) may be performed to clean up the patterned conductive layer, die singulation, wafer bonding, die bonding, bump-bonding, chip packaging, and/or the like. During performance of the one or more additional or remaining processes, the secondary protective layer and/or primary protective layer protect the TCF(s) located within respective window regions from being affected (e.g., damaged, saturated with oxygen, and/or the like) during performance of the one or more additional or remaining processes.

At step 1012, if a secondary protective layer is present, at least a portion of the secondary protective layer is removed. For example, a (chemically selective) wet etch may be used to remove the exposed portion of the secondary protective layer. For example, as shown in FIG. 12E, the secondary protective layer 1272 that is exposed via the window opening 1258 is removed. A residual portion 1274 of the secondary protective layer 1272 that is covered by the segment 1252 of the patterned conductive layer may remain.

In some embodiments, after removing the secondary protective layer and before removing the primary protective layer, one or more additional and/or remaining fabrication processes are performed, at step 1014. For example, the secondary protective layer may be configured for protecting the TCF during a first set of additional and/or remaining fabrication processes performed at step 1010. The secondary protective layer may be removed after performance of the first set of additional and/or remaining fabrication processes at step 1012. A second set of additional and/or remaining fabrication steps may then be performed between steps 1012 and 1016. For example, the primary protective layer may be configured to protect the TCF during a second set of additional and/or remaining fabrication processes performed between steps 1012 and 1016.

At step 1016, at least a portion of the primary protective layer is removed. For example, a wet or chemical selective etch may be used to remove the exposed portion of the primary protective layer. In various embodiments, the wet or chemical selective etch used to remove the exposed portion of the primary protective layer does not affect or interact with the TCF. In an example embodiment, a wet etch, using hydrogen peroxide, for example, may be used to remove a primary protective layer and/or a secondary protective layer. For example, as shown in FIG. 12F, the primary protective layer 1270 that is exposed via the window opening 1258 is removed. A residual portion 1276 of the primary protective layer 1270 that is covered by the segment 1252 of the patterned conductive layer may remain. Removal of the exposed portion of the primary protective layer 1270 finishes fabrication of the transparent conductive window 1260 comprising the TCF 1262 and defined at least in part by the window opening 1258.

In various embodiments, the TCF 1262 is in electrical communication with the segment 1252 having the window opening 1258 defined therethrough. In some embodiments, the TCF 1262 is in direct physical contact with the segment 1252 and is in electrical communication with the segment 1252 thereby. In some embodiments, the TCF 1262 is in physical contact with the segment 1252, at least in part, via the residual portion 1276 of the primary protective layer 1270. For example, the primary protective layer may comprise an electrically conductive material such that the residual portion 1276 of the primary protective layer 1270 is configured to place the TCF 1262 into electrical communication with the segment 1252 having the window opening 1258 defined therethrough.

In certain embodiments, at step 1018, an annealing may be performed in a low oxygen environment. For example, an annealing process in a low oxygen environment may be performed on the chip to cause oxygen to be released by the TCF such that the resistance and/or optical transmission of the TCF is returned to close to the original, as-deposited performance of the TCF. For example, in certain embodiments, after performance of the one or more additional processes, a low oxygen environment annealing process is performed to cause oxygen to be released from the TCF(s) of the one or more transparent conductive windows of the chip.

In various embodiments, the annealing process comprises heating the chip to a temperature between 250 and 500 degrees Celsius for a time of at least half an hour. In an example embodiment, the annealing process is performed for up to 48 hours. For example, the annealing process is performed at a temperature that will not affect the other components of the chip (e.g., the segments of the patterned conductive layer, the electrical routing layer(s), the insulating layer(s), the waveguide and couplers of the optical routing layer(s), and/or the like). In various embodiments, the annealing process comprises heating the chip to a temperature between 300 and 400 degrees Celsius for a time in a range of one hour (at least an hour and a half, in some embodiments) to five hours. In some embodiments, the annealing is a rapid thermal anneal where the chip is heated to a temperature of 450-550 degrees Celsius (e.g., 500 degrees Celsius) for up to two minutes (e.g., 30 seconds).

In various embodiments, the low oxygen environment is one of a vacuum environment or an environment having a gas flow of a gas that substantially does not include oxygen. For example, the anneal may be performed in an environment that has a reduced oxygen content (e.g., compared to air). The reduced oxygen content of the low oxygen environment may be achieved via a vacuum environment or via an environment having a as flow of a gas that substantially does not include oxygen (e.g., a generally inert gas and/or other gas not including oxygen such as a reducing atmospheres such as forming gas).

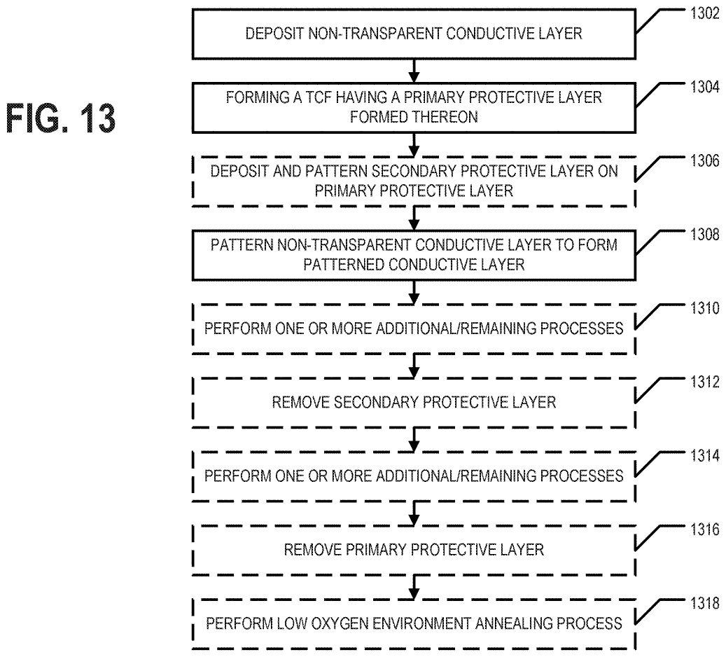

FIG. 13 provides a flowchart illustrating various processes and/or procedures for fabricating a chip (e.g., a confinement apparatus chip 200 and/or a second chip 300) using one or more protective layers to protect a TCF fabricated on a non-transparent conductive layer, according to another example embodiment.

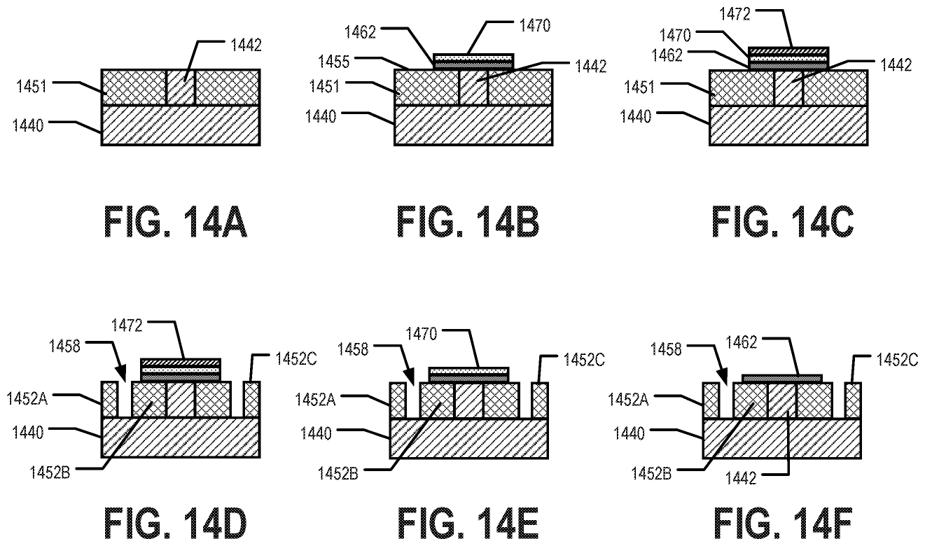

Starting at step 1302, a non-transparent conductive layer is deposited. For example, the non-transparent conductive layer is deposited on an insulating layer. In various embodiments, the non-transparent conductive layer comprises a metal that is deposited via a sputtering technique, ALD, PVD, CVD, and/or the like. In some embodiments, prior to depositing the non-transparent conductive layer, one or more optically transparent pillars extending from a surface of the insulating layer are patterned. In various embodiments, the optically transparent pillars may comprise dielectric and/or oxide material that is transparent for at least a subset of optical wavelengths. For example, optically transparent pillars may be configured to provide respective optical paths through the non-transparent conductive layer. FIG. 14A illustrates a non-transparent conductive layer 1451 deposited onto an insulating layer 1440. The non-transparent conductive layer 1451 is deposited around a dielectric and/or oxide pillar 1442.

At step 1304, one or more TCFs are formed each having a respective primary protective layer formed thereon. In various embodiments, the TCF is formed on a substantially planar surface of the non-transparent conductive layer. For example, as shown in FIG. 14B, at least one TCF 1462 is formed on a substantially planar surface 1455 of an insulating layer 1440 of a chip (e.g., confinement apparatus chip 200 and/or second chip 300). A primary protective layer 1470 is formed on the TCF 1462. In various embodiments, the TCF 1462 is (optically) aligned with a respective dielectric and/or oxide pillar 1442. In various embodiments, the TCF 1462 is in direct electrical communication with the non-transparent conductive layer 1451 and/or in electrical communication with the non-transparent conductive layer 1451 via an adhesion layer.

In various embodiments, the TCF 1462 comprises a TCO, such as ITO and/or the like. In various embodiments, the primary protective layer 1470 may be strippable or removeable using a wet and/or chemically selective etch that substantially does not affect other materials of the chip. For example, the primary protective layer 1470 may be strippable or removeable using a wet and/or chemically selective etch that substantially does not affect the material of the patterned conductive layer, TCF, or insulating layer. In certain embodiments, the primary protective layer 1470 comprises W, TiW, Ge, TiN and/or the like.

In various embodiments, one or more TCFs are formed each having a respective primary protective layer formed thereon are fabricated according to a method illustrated by FIG. 11A or FIG. 11B. FIGS. 11A and 11B provide respective flowcharts illustrating various processes and/or procedures of two example methods for forming one or more TCFs having respective primary protective layers formed thereon. For example, starting with step 1102 of FIG. 11A, a TCL is deposited on the substantially planar surface of the non-transparent conductive layer. In various embodiments, the TCL is deposited using a sputtering technique, an evaporation technique (e.g., thermal or electron beam evaporation), ALD, PVD, CVD, and/or the like. In various embodiments, the TCL is a thin layer. For example, the TCL may have a thickness in a direction perpendicular the substantially planar surface in a range of 1 nm to 10 microns (e.g., 10-40 nm, 50 nm, or 500 nm, in various embodiments depending on the material of the TCL). In various embodiments, the patterning of the TCL and/or the first primary protective layer may be performed using lithographic process, damascene processes, or other appropriate patterning processes. In some embodiments, the TCL and/or the first primary protective layer is not patterned until after deposition of the conductive non-transparent layer.

At step 1104, the primary protective layer is deposited on the TCL. In various embodiments, the primary protective layer may be deposited using sputtering technique, ALD, PVD, CVD, and/or the like.

At step 1106, the TCL and primary protective layer is patterned to define one or more TCFs having respective primary protective layer formed thereon. For example, in certain embodiments, a wet and/or selective chemical etch may be used to pattern the primary protective layer and a different wet or chemically selective etch or a method in accordance with one of FIG. 8 or FIG. 9 may be used to pattern the TCL to form the TCF(s). In an example embodiment, the primary protective layer and the TCL are patterned using a dry etch to define the TCF having the primary protective layer formed thereon.

FIG. 11B provides an alternative method for forming a TCF having a primary protective layer formed thereon. Starting at step 1122, a TCL is deposited on the substantially planar surface of the non-transparent conductive layer. In various embodiments, the TCL is deposited using a sputtering technique, ALD, PVD, CVD, and/or the like. In various embodiments, the TCL is a thin layer. For example, the TCL may have a thickness in a direction perpendicular the substantially planar surface in a range of 1 nm to 10 microns (e.g., 10-40 nm, 50 nm, or 500 nm, in various embodiments depending on the material of the TCL).

At step 1124, the transparent conductive layer is patterned to form one or more TCFs. In various embodiments, a wet or chemically selective etch or a method in accordance with one of FIG. 8 or FIG. 9 may be used to pattern the TCL to form the TCF(s).

At step 1126, the primary protective layer is deposited on the TCF(s) and the surface of the insulating layer. In various embodiments, the primary protective layer may be deposited using sputtering technique, ALD, PVD, CVD, and/or the like.

At step 1128, the primary protective layer is patterned to form the respective primary protective layers on the one or more TCFs. In various embodiments, the primary protective layer is patterned using a wet or selective chemical etch that is inert and/or does not affect the TCF(s).

Returning to FIG. 13, at step 1306, in some embodiments, a secondary protective layer is deposited onto the primary protective layer, any exposed surface portion of the TCF, and the exposed surface portion of the non-transparent conductive layer. The secondary protective layer is patterned to define respective secondary protective layer portions disposed on the first protective layer formed on the one or more TCFs. For example, FIG. 14C illustrates a secondary protective layer 1472 patterned onto the primary protective layer 1470 that is formed on a TCF 1462. The secondary protective layer 1472 may not completely cover the primary protective layer 1470. In various embodiments, the secondary protective layer 1472 may comprise a plurality of layers of one or more materials. For example, the secondary protective layer 1472 may comprise a plurality of films.

In various embodiments, the secondary protective layer 1472 is strippable or removeable using a dry etch using the primary protective layer 1470 as an etch stop. In certain embodiments, the primary protective layer 1470 comprises W, Ge, TiN, and/or TiW and the secondary protective layer 1472 comprises Si, amorphous Si (aSi), SiO₂, Al, Ti and/or TiO₂, Au, Pt, TiN, spin on glass, and/or another material. In various embodiments, the secondary protective layer 1472 may be deposited using a sputtering technique, ALD, PVD, CVD, and/or the like. In various embodiments, the secondary protective layer 1472 is patterned using a patterned (dry) etch, with a lithographic mask, for example.

In various embodiments, the secondary protective layer 1472 is configured to protect the primary protective layer 1470 during the performance of one or more additional and/or remaining processes. For example, the primary protective layer 1470 may not be fully inert to at least one process of the one or more additional processes. The secondary protective layer 1472 may be selected to be sufficiently inert to the one or more additional and/or remaining processes such that the secondary protective layer 1472 protects the primary protective layer 1470 during performance of the one or more additional or remaining processes.

Continuing with FIG. 13, at step 1308, the non-transparent conductive layer is patterned to form the patterned conductive layer. For example, the non-transparent conductive layer may be etched to define segments of the patterned conductive layer with at least one segment including a window opening etched therethrough. For example, the non-transparent conductive layer may be patterned in accordance with the method illustrated by FIG. 6. For example, FIG. 14D illustrates the non-transparent conductive layer 1451 etched to define a segments 1452 (e.g., 1452A, 1452B, 1452C) of a patterned conductive layer and gaps 1458 etched through the non-transparent conductive layer so as to spatially separate adjacent segments 1452.

Returning to FIG. 13, at step 1310, one or more additional or remaining processes are performed. In various embodiments, the one or additional processes may include undercut etchings to form undercut gaps between adjacent segments 1452 of the patterned conductive layer, etching load holes, performing clean up processes (e.g., an O₂ plasma clean and/or the like) may be performed to clean up the patterned conductive layer and/or other components of the chip, die singulation, wafer bonding, die bonding, bump-bonding, chip packaging, and/or the like. During performance of the one or more additional or remaining processes, the secondary protective layer and/or primary protective layer protect the TCF(s) located within respective window regions from being affected (e.g., damaged, saturated with oxygen, and/or the like) during performance of the one or more additional or remaining processes.

At step 1312, if a secondary protective layer is present, at least a portion of the secondary protective layer is removed. For example, a (chemically selective) wet etch may be used to remove the exposed portion of the secondary protective layer. For example, as shown in FIG. 14E, the secondary protective layer 1472 is removed.

In some embodiments, after removing the secondary protective layer and before removing the primary protective layer, one or more additional and/or remaining fabrication processes are performed, at step 1314. For example, the secondary protective layer may be configured for protecting the TCF during a first set of additional and/or remaining fabrication processes performed at step 1310. The secondary protective layer may be removed after performance of the first set of additional and/or remaining fabrication processes at step 1312. A second set of additional and/or remaining fabrication steps may then be performed between steps 1312 and 1316. For example, the primary protective layer may be configured to protect the TCF during a second set of additional and/or remaining fabrication processes performed between steps 1312 and 1316.

At step 1316, at least a portion of the primary protective layer is removed. For example, a wet or chemical selective etch may be used to remove the primary protective layer. In various embodiments, the wet or chemical selective etch used to remove the exposed portion of the primary protective layer does not affect or interact with the TCF. In an example embodiment, a wet etch, using hydrogen peroxide, for example, may be used to remove a primary protective layer and/or a secondary protective layer. For example, as shown in FIG. 14F, the primary protective layer 1470 is removed.

In certain embodiments, at step 1318, an annealing may be performed in a low oxygen environment. For example, an annealing process in a low oxygen environment may be performed on the chip to cause oxygen to be released by the TCF such that the resistance and/or optical transmission of the TCF is returned to close to the original, as-deposited performance of the TCF. For example, in certain embodiments, after performance of the one or more additional processes, a low oxygen environment annealing process is performed to cause oxygen to be released from the TCF(s) of the one or more transparent conductive windows of the chip.

In various embodiments, the annealing process comprises heating the chip to a temperature between 250 and 500 degrees Celsius for a time of at least half an hour. In an example embodiment, the annealing process is performed for up to 48 hours. For example, the annealing process is performed at a temperature that will not affect the other components of the chip (e.g., the segments of the patterned conductive layer, the electrical routing layer(s), the insulating layer(s), the waveguide and couplers of the optical routing layer(s), and/or the like). In various embodiments, the annealing process comprises heating the chip to a temperature between 300 and 400 degrees Celsius for a time in a range of one hour (at least an hour and a half, in some embodiments) to five hours.

In various embodiments, the low oxygen environment is one of a vacuum environment or an environment having a gas flow of a gas that substantially does not include oxygen. For example, the anneal may be performed in an environment that has a reduced oxygen content (e.g., compared to air). The reduced oxygen content of the low oxygen environment may be achieved via a vacuum environment or via an environment having a flow of a gas that substantially does not include oxygen (e.g., a generally inert gas and/or other gas not including oxygen such as a reducing atmospheres such as forming gas, for example).

### Technical Advantages

Various embodiments provide confinement apparatus assemblies; quantum computers, atomic systems, and/or quantum systems comprising confinement apparatus assemblies; and/or the like. The confinement apparatus assemblies include integrated transparent conductive windows that are integrated into the confinement apparatus assembly (e.g., as part of the confinement apparatus chip and/or as part of a second substrate and/or chip). Each transparent conductive window includes a transparent conductive film (TCF) configured to enable manipulation signal (e.g., optical signals to pass there through) and that are conductive and in electrical communication with various other conductive components of the confinement apparatus assembly to prevent build-up of charge on the TCF. The TCF is disposed between a patterned conductive layer (e.g., a top metal or electrode layer) and an insulating layer (e.g., a dielectric layer) of the respective chip (e.g., the confinement apparatus chip and/or a second substrate and/or chip). The confinement apparatus may also include gaps between adjacent segments or electrodes of the patterned conductive layer or load holes that are overhung by the neighboring segments or electrodes of the patterned conductive layer.

Various embodiments provide methods for fabricating confinement apparatus assemblies where the transparent conductive film (TCF) of a transparent conductive window is present for one or more integrated fabrication operations, such as the fabrication of the patterned conductive layer, undercut etches between adjacent segments and/or electrodes of the patterned conductive layer, load hole etches, patterned conductive layer clean-up, die singulation, wafer bonding, die bonding, bump-bonding, chip packaging, and/or the like. Some embodiments include processes and/or procedures for protecting the TCF of a transparent conductive window during performance of integrated fabrication operations. Some embodiments include processes and/or procedures for repairing the TCF of a transparent conductive window that occurs during performance of integrated fabrication operations.

For example, the TCF may be damaged and/or saturated with oxygen (or other element and/or chemical) during the performance of the integrated fabrication operations. This may result in the TCF having reduced electrical conductivity, increased electrical resistance, reduced optical transparency, and/or the like. Decreased electrical conductivity and/or increased electrical resistance of the TCF may cause heating of quantum and/or atomic objects confined by the confinement apparatus 202 and/or may cause the quantum and/or atomic objects confined by the confinement apparatus 202 to experience spurious electric fields that may result in memory errors. Reduced optical transparency of the TCF film of a transparent conductive window may reduce the optical power of a manipulation signal and/or affect other optical properties of the manipulation signal that is provided to a target location through the transparent conductive window. Therefore, there are technical problems regarding confinement apparatus assemblies having integrated transparent conductive windows and methods for fabricating such confinement apparatus assemblies.

One solution to these technical problems may be to fabricate the TCF of transparent conductive windows as a final step in the fabrication of the confinement apparatus chip and/or second substrate and/or chip. However, this strategy does not appear to provide sufficient electrical communication between the TCF and the top-metal to prevent excess heating and/or to perform sufficient shielding from spurious electric fields caused by electric charge build-up. For example, simulations indicate that the electrical resistance between the TCF and the top-metal may be on the order of 2000 ohms.

Various embodiments provide technical solutions to these technical challenges. For example, in various embodiments, the TCF of a transparent conductive window is disposed between a patterned conductive layer (e.g., a top metal or electrode layer) and an insulating layer (e.g., a dielectric layer) of the respective chip (e.g., the confinement apparatus chip and/or a second substrate and/or chip). The confinement apparatus may also include gaps between adjacent segments or electrodes of the patterned conductive layer or load holes that are overhung by the neighboring segments or electrodes of the patterned conductive layer. The overhanging portions of the segments or electrodes may provide additional shielding of quantum and/or atomic objects confined by the confinement apparatus from spurious electric fields. In some embodiments, the respective chip further includes an intermediate conductive layer disposed between the insulating layer and an optical routing layer of the chip to further shield quantum and/or atomic objects confined by the confinement apparatus from spurious electric fields generated in the electrical routing layers, optical routing layers, and/or other layers of the chip.

Some embodiments include processes and/or procedures for protecting the TCF of a transparent conductive window during performance of integrated fabrication operations. Some embodiments include processes and/or procedures for repairing the TCF of a transparent conductive window that occurs during performance of integrated fabrication operations. These processes and/or procedures for protecting and/or repairing the TCF of a transparent conductive window provide transparent conductive windows having TCFs integrated between the patterned conductive layer and the insulating layer of the respective chip to provide sufficient electrical communication between the TCF and patterned conductive layer where the TCF has sufficient electrical conductivity and optical transparency to effectively prevent excess heating of quantum and/or atomic objects confined by the confinement apparatus, shield quantum and/or atomic objects confined by the confinement apparatus from spurious electric fields, and provide manipulation signals (e.g., optical signals) of desired optical properties.

Therefore, various embodiments provide improvements to the fields of confinement apparatus assemblies including integrated photonics, systems including confinement apparatus assemblies that use integrated photonics for manipulating confined quantum and/or atomic objects, and/or the like.

### Exemplary Controller

In various embodiments, a confinement apparatus assembly 90 is incorporated into a quantum computer 110 or other atomic system and/or quantum system. In various embodiments, a quantum computer 110 further comprises a controller 30 configured to control various elements of the quantum computer 110. For example, the controller 30 may be configured to control the voltage sources 50, a cryogenic system and/or vacuum system controlling the temperature and pressure within the cryogenic and/or vacuum chamber 40, manipulation sources 64, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum and/or atomic objects confined by the confinement apparatus 202.

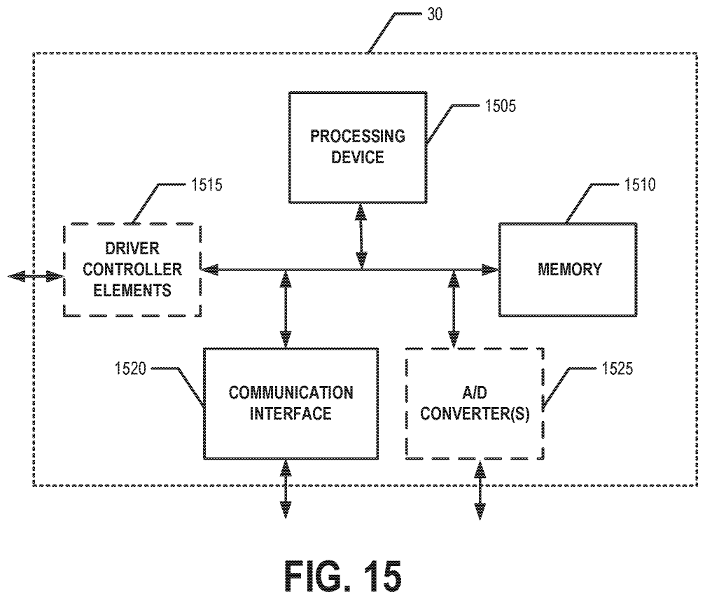

As shown in FIG. 15, in various embodiments, the controller 30 may comprise various controller elements including processing elements 1505, memory 1510, driver controller elements 1515, a communication interface 1520, analog-digital converter elements 1525, and/or the like. For example, the processing elements 1505 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 1505 of the controller 30 comprises a clock and/or is in communication with a clock.

For example, the memory 1510 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1510 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 1510 (e.g., by a processing element 1505) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 1515 may include one or more drivers and/or controller elements each configured to control one or more drivers. In various embodiments, the driver controller elements 1515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 1505). In various embodiments, the driver controller elements 1515 may enable the controller 30 to operate a manipulation source 60. In various embodiments, the drivers may be laser drivers; vacuum component drivers; drivers for controlling the flow of current and/or voltage applied to control, RF rail, shim, and/or other electrodes used for maintaining and/or controlling the trapping (pseudo-)potential of the confinement apparatus 202; cryogenic and/or vacuum system component drivers; and/or the like. For example, the drivers may control and/or comprise control, RF, and/or shim voltage drivers and/or voltage sources that provide voltages and/or electrical signals to the control electrodes, shim electrodes, and/or RF rail electrodes (e.g., segments of the patterned conductive layer) via respective leads and/or vias.

In various embodiments, the controller 30 comprises means for communicating and/or receiving signals from one or more sensors and/or optical receiver components of the optics collection system 80, such as cameras, MEMs cameras, CCD cameras, photodiodes, photomultiplier tubes, and/or the like. For example, the controller 30 may comprise one or more analog-digital converter elements 1525 configured to receive signals from one or more optical receiver components, calibration sensors, and/or the like.

In various embodiments, the controller 30 may comprise a communication interface 1520 for interfacing and/or communicating with a computing entity 10. For example, the controller 30 may comprise a communication interface 1520 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Exemplary Computing Entity

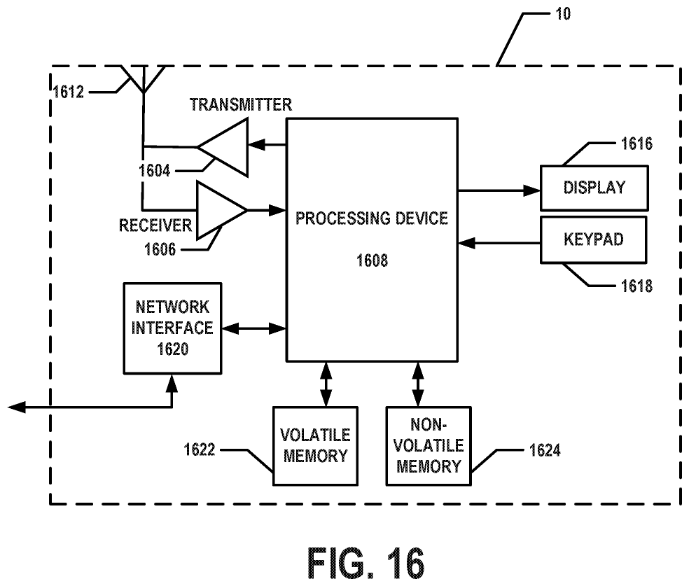

FIG. 16 provides an illustrative schematic representative of an example computing entity 10 that can be used in conjunction with embodiments of the present invention. In various embodiments, a computing entity 10 is a classical and/or semiconductor-based computing entity that is configured to allow a user to provide input to the quantum computer 110 (e.g., via a user interface of the computing entity 10) and receive, display, analyze, and/or the like output from the quantum computer 110.

As shown in FIG. 16, a computing entity 10 can include an antenna 1612, a transmitter 1604 (e.g., radio), a receiver 1606 (e.g., radio), and a processing element 1608 that provides signals to and receives signals from the transmitter 1604 and receiver 1606, respectively. The signals provided to and received from the transmitter 1604 and the receiver 1606, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 1620 configured for communicating via one or more wired and/or wireless networks 20.

The computing entity 10 may also comprise a user interface device comprising one or more user input/output interfaces (e.g., a display 1616 and/or speaker/speaker driver coupled to a processing element 1608 and a touch screen, keyboard, mouse, and/or microphone coupled to a processing element 1608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1618 (hard or soft), a touch display, voice/speech or motion interfaces, scanners, readers, or other input device. In embodiments including a keypad 1618, the keypad 1618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1622 and/or non-volatile storage or memory 1624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A chip configured for delivering a manipulation signal to a target location, the chip comprising:
a plurality of layers, the plurality of layers comprising sub-surface layers and a patterned conductive layer disposed at a delivery surface of the chip; and
a transparent conductive film (TCF) disposed between the patterned conductive layer and at least one of the sub-surface layers such that the TCF is in electrical communication with at least a portion of the patterned conductive layer.

2. The chip of claim 1, wherein one or more through holes are formed through the plurality of layers and respective portions of the patterned conductive layer overhang the one or more through holes.

3. The chip of claim 1, wherein the sub-surface layers comprise at least one of (a) one or more optical routing layers comprising at least one waveguide or (b) one or more electrical routing layers, a window opening is disposed in the patterned conductive layer and defines an opening area and the TCF is optically aligned with the window opening.

4. The chip of claim 3, further comprising one or more insulating layers disposed between the patterned conductive layer and the at least one of (a) one or more optical routing layers and (b) one or more electrical routing layers, wherein the patterned conductive layer is segmented into conductive segments that are spatially separated from one another with respective gaps in the insulating layer between adjacent conductive segments.

5. The chip of claim 4, wherein one or more metasurfaces are disposed within the one or more insulating layers, each of the one or more metasurfaces aligned with a respective optical path defined at least in part by a coupler of the optical routing layer and the transparent conductive window.

6. The chip of claim 4, wherein the adjacent conductive segments overhang the respective gaps.

7. The chip of claim 4, wherein the TCF extends between the insulating layer and the patterned conductive layer beyond an edge of the window opening.

8. The chip of claim 4, further comprising one or more intermediate conductive layers disposed between the optical routing layer and the insulating layer, the intermediate conductive layer being patterned to include an aperture therethrough that is optically aligned with the TCF and the window opening.

9. The chip of claim 3, wherein the optical routing layer comprises at least one coupler configured to couple the manipulation signal out of the at least one waveguide such that the manipulation signal propagates through the window and through the window opening to the target location.

10. The chip of claim 9, wherein the manipulation signal is an optical beam.

11. The chip of claim 10, wherein the at least one coupler is configured to control one or more optical properties of the manipulation signal.

12. The chip of claim 1, wherein the chip hosts a confinement apparatus configured to confine one or more quantum objects in a confinement region proximate the delivery surface and the patterned conductive layer comprises a plurality of electrodes of the confinement apparatus.

13. The chip of claim 1, wherein the chip is configured to be secured with respect to a confinement apparatus such that the delivery surface faces a confinement region defined by the confinement apparatus.

14. The chip of claim 1, further comprising a residual portion of a protect layer disposed between the TCF and the patterned conductive layer.

15. A chip configured for delivering a manipulation signal to a target
location, the chip comprising:
one or more sub-surface layers comprising an insulating layer comprising a dielectric material and at least one of (a) an optical routing layer comprising at least one waveguide or (b) an electrical routing layer;
a patterned conductive layer, wherein the insulating layer is disposed between at least one of the one or more sub-surface layers and the patterned conductive layer and the patterned conductive layer includes at least one window opening defining an opening area; and
at least one window disposed between the insulating layer and the patterned conductive layer, the at least one window comprising a transparent conductive film (TCF), wherein the window is aligned with the at least one window opening in the patterned conductive layer, the window defines a window area, and the window area is larger than the opening area and wherein the TCF is in electrical communication with at least a segment of the patterned conductive layer.

16. The chip of claim 15, wherein at least one of:
one or more through holes are formed through the optical routing layer, insulating layer, and patterned conductive layer,
respective portions of the patterned conductive layer overhang the one or more through holes,
the patterned conductive layer is segmented into conductive segments with respective gaps in the insulating layer between adjacent conductive segments, or
the adjacent conductive segments overhang the respective gaps.

17. The chip of claim 15, wherein the optical routing layer comprises at least one coupler configured to couple the manipulation signal out of the at least one waveguide such that the manipulation signal propagates through the at least one window and through the window opening to the target location.

18. The chip of claim 15, wherein at least one of:
the chip hosts a confinement apparatus configured to confine one or more quantum objects in a confinement region proximate the delivery surface and the patterned conductive layer comprises a plurality of electrodes of the confinement apparatus, or the chip is configured to be secured with respect to a confinement apparatus such that the delivery surface faces a confinement region defined by the confinement apparatus.

19. The chip of claim 15, further comprising an intermediate conductive layer disposed between the optical routing layer and the insulating layer, the intermediate conductive layer being patterned to include an aperture therethrough that is optically aligned with the at least one window and the window opening.

20. The chip of claim 19, further comprising a second TCF that is disposed at least partially across the aperture and in electrical communication with the intermediate conductive layer.

21-75. (canceled)
